(19) United States
(12) Patent Application Publication
(10) Pub. No.: US 2026/0218717 A1
(43) Pub. Date: Jul. 30, 2026

(54) BLOWER

(71) Applicant: Makita Corporation, Anjo-shi (JP)

(72) Inventors: Daigo FUJIWARA, Anjo-shi (JP); Kouichi TAKEDA, Anjo-shi (JP)

(73) Assignee: Makita Corporation, Anjo-shi (JP)

(21) Appl. No.: 19/462,355

(22) Filed: Jan. 28, 2026

(30) Foreign Application Priority Data
Jan. 30, 2025 (JP) 2025-013558
Nov. 28, 2025 (JP) 2025-207530

(51) Int. Cl. F04D 27/00; F04D 25/06; H02P 3/22

(52) U.S. Cl. CPC F04D 27/008; F04D 25/06; F04D 27/001; H02P 3/22; H02P 2207/05

(57) ABSTRACT

A blower includes a fan, a prime mover, an intake port, an intake port attachment member, an intake port detection sensor, an operation member, an operation detection sensor, and a control unit. The intake port detection sensor is in a first state when the attachment member is attached and in a second state when it is not attached. The control unit drives the prime mover when the intake port detection sensor is in the first state and the operation detection sensor is ON, stops the prime mover when the intake port detection sensor is in the first state and the operation detection sensor is OFF, and stops and then prohibits driving the prime mover when the intake port detection sensor shifts from the first state to the second state while the operation detection sensor is ON until the operation detection sensor shifts from ON to OFF.

### REFERENCE TO RELATED APPLICATIONS

This application claims priority to Japanese Patent Application No. 2025-013558 filed on January 30, 2025 and Japanese Patent Application No. 2025-207530 filed on November 28, 2025. The entire contents of the priority applications are incorporated herein by reference.

### TECHNICAL FIELD

The technology disclosed herein relates to a blower.

### BACKGROUND ART

Japanese Patent Application Publication No. 2012-021470 describes a blower. The blower includes: a fan; a prime mover configured to rotate the fan; an intake port through which air flows in due to rotation of the fan, wherein the intake port allows access to the fan from outside; an intake port attachment member detachably attachable to the intake port; an intake port detection sensor configured to be in a first state when the intake port attachment member is attached to the intake port and be in a second state when the intake port attachment member is not attached to the intake port; an operation member configured to receive an operation for rotating the fan; an operation detection sensor configured to detect whether the operation is performed on the operation member or not; and a control unit configured to control the prime mover. The control unit is configured to drive the prime mover in case the intake port detection sensor is in the first state and the operation detection sensor is in an ON state; to stop the prime mover in case the intake port detection sensor is in the first state and the operation detection sensor is in an OFF state; and to stop the prime mover in case the intake port detection sensor shifts from the first state to the second state while the operation detection sensor is in the ON state.

### SUMMARY

In the above-described blower, the prime mover is stopped when the intake port attachment member is detached from the intake port while the operation detection sensor is in the ON state, but when the intake port attachment member is subsequently attached to the intake port while the operation detection sensor is still in the ON state, the prime mover is driven again. Thus, if a user has forgotten that the operation detection sensor is still in the ON state after the prime mover was stopped in response to the detachment of the intake port attachment member from the intake port and attaches the intake port attachment member to the intake port, the prime mover is driven contrary to the user’s expectation. The disclosure herein provides a technology that prevents a prime mover from being driven unexpectedly.

Disclosed herein is a blower. The blower may comprise a fan; a prime mover configured to rotate the fan; an intake port through which air flows in due to rotation of the fan, wherein the intake port allows access to the fan from outside; an intake port attachment member detachably attachable to the intake port; an intake port detection sensor configured to be in a first state when the intake port attachment member is attached to the intake port and be in a second state when the intake port attachment member is not attached to the intake port; an operation member configured to receive an operation for rotating the fan; an operation detection sensor configured to detect whether the operation is performed on the operation member or not; and a control unit configured to control the prime mover. The control unit may be configured to drive the prime mover in case the intake port detection sensor is in the first state and the operation detection sensor is in an ON state; to stop the prime mover in case the intake port detection sensor is in the first state and the operation detection sensor is in an OFF state; and to stop the prime mover in case the intake port detection sensor shifts from the first state to the second state while the operation detection sensor is in the ON state, and thereafter, to prohibit driving the prime mover until the operation detection sensor shifts from the ON state to the OFF state.

The above configuration stops the prime mover when the intake port attachment member is detached from the intake port while the operation detection sensor is in the ON state and prohibits driving the prime mover until the operation detection sensor subsequently shifts from the ON state to the OFF state. Therefore, if a user has forgotten that the operation detection sensor is still in the ON state after the prime mover was stopped in response to the detachment of the intake port attachment member from the intake port and attaches the intake port attachment member to the intake port, the prime mover will not be driven. The above configuration thus prevents the prime mover from being driven unexpectedly.

Also disclosed herein is another blower. The blower may comprise a fan; a prime mover configured to rotate the fan; a detachable attachment member; an attachment detection sensor configured to be in a first state when the attachment member is attached and be in a second state when the attachment member is not attached; an operation member configured to receive an operation for rotating the fan; an operation detection sensor configured to detect whether the operation is performed on the operation member or not; and a control unit configured to control the prime mover. The control unit may be configured to drive the prime mover in case the attachment detection sensor is in the first state and the operation detection sensor is in an ON state; to stop the prime mover in case the attachment detection sensor is in the first state and the operation detection sensor is in an OFF state; and to stop the prime mover in case the attachment detection sensor shifts from the first state to the second state while the operation detection sensor is in the ON state, and thereafter, to prohibit driving the prime mover until the operation detection sensor shifts from the ON state to the OFF state.

The above configuration stops the prime mover when the attachment member is detached while the operation detection sensor is in the ON state and prohibits driving the prime mover until the operation detection sensor subsequently shifts from the ON state to the OFF state. Therefore, if a user has forgotten that the operation detection sensor is still in the ON state after the prime mover was stopped in response to the detachment of the attachment member and attaches the attachment member, the prime mover will not be driven. The above configuration thus prevents the prime mover from being driven unexpectedly.

### BRIEF DESCRIPTION OF DRAWINGS

FIG. 1 is a perspective view of a blower 2 according to a first embodiment as viewed from the upper rear left side.

FIG. 2 is a perspective view of the blower 2 according to the first embodiment as viewed from the upper front right side, where an intake port cover 18 is open.

FIG. 3 is a perspective view of the blower 2 according to the first embodiment as viewed from the upper front right side, where the blower 2 is in a state for a blow operation.

FIG. 4 is a perspective view of the blower 2 according to the first embodiment as viewed from the upper front right side, where the blower 2 is in a state for a suction operation.

FIG. 5 is a longitudinal cross-sectional view of the blower 2 according to the first embodiment.

FIG. 6 is a perspective view of the blower 2 according to the first embodiment as viewed from the upper rear left side, where a control unit housing 42 is detached.

FIG. 7 is a perspective view of an internal structure of a handle portion 44 of the blower 2 according to the first embodiment as viewed from the upper front left side, where a blow nozzle 28 is attached to an exhaust port 16.

FIG. 8 is a perspective view of a structure near a second detection switch 84 of the blower 2 according to the first embodiment as viewed from the upper front right side, where a switch cover 86 is detached.

FIG. 9 is a diagram schematically illustrating a configuration of a control unit 10 of the blower 2 according to the first embodiment.

FIG. 10 is a flowchart of an exemplary process performed by the control unit 10 of the blower 2 according to the first embodiment.

FIG. 11 is a flowchart of another exemplary process performed by the control unit 10 of the blower 2 according to the first embodiment.

FIG. 12 is a perspective view of a blower 202 according to a second embodiment as viewed from the upper front left side.

FIG. 13 is a perspective view of the blower 202 according to the second embodiment as viewed from the upper front left side, where a suction nozzle 208 and a collection bag 222 are detached.

FIG. 14 is a right cross-sectional view of an internal structure of the blower 202 according to the second embodiment.

FIG. 15 is a right cross-sectional view of the internal structure of the blower 202 according to the second embodiment.

FIG. 16 is a perspective view of a fan 230 according to the second embodiment as viewed from the upper front left side.

FIG. 17 is a cross-sectional view of a volute passage 258 and its surrounding area of the blower 202 according to the second embodiment, taken along a line XVII-XVII in FIG. 14.

FIG. 18 is a right side view of the blower 202 according to the second embodiment, where a maintenance cover 298 is in an open position.

FIG. 19 is a right side view of the blower 202 according to the second embodiment, where the maintenance cover 298 is in a closed position.

FIG. 20 is a diagram schematically illustrating a configuration of a control unit 228 of the blower 202 according to the second embodiment.

FIG. 21 is a flowchart of an exemplary process performed by the control unit 228 of the blower 202 according to the second embodiment.

FIG. 22 is a flowchart of another exemplary process performed by the control unit 228 of the blower 202 according to the second embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved blowers, as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a blower may comprise a fan; a prime mover configured to rotate the fan; an intake port through which air flows in due to rotation of the fan, wherein the intake port allows access to the fan from outside; an intake port attachment member detachably attachable to the intake port; an intake port detection sensor configured to be in a first state when the intake port attachment member is attached to the intake port and be in a second state when the intake port attachment member is not attached to the intake port; an operation member configured to receive an operation for rotating the fan; an operation detection sensor configured to detect whether the operation is performed on the operation member or not; and a control unit configured to control the prime mover. The control unit may be configured to drive the prime mover in case the intake port detection sensor is in the first state and the operation detection sensor is in an ON state; to stop the prime mover in case the intake port detection sensor is in the first state and the operation detection sensor is in an OFF state; and to stop the prime mover in case the intake port detection sensor shifts from the first state to the second state while the operation detection sensor is in the ON state, and thereafter, to prohibit driving the prime mover until the operation detection sensor shifts from the ON state to the OFF state.

In one or more embodiments, the control unit may be configured to stop the prime mover in case the intake port detection sensor shifts from the first state to the second state while the operation detection sensor is in the ON state; not to prohibit driving the prime mover until a predetermined period elapses since the prime mover was stopped; and after the predetermined period has elapsed from when the prime mover was stopped, to prohibit driving the prime mover until the operation detection sensor shifts from the ON state to the OFF state.

The intake port detection sensor may repeatedly shift between the first state and the second state within a short period of time, for example, due to chattering. If the prime mover is prohibited from being driven until the operation detection sensor shifts from the ON state to the OFF state in such a case after the prime mover was stopped in response to the intake port detection sensor having shifted from the first state to the second state, user convenience may be impaired. According to the configuration above, in such a case where the intake port detection sensor repeatedly shifts between the first state and the second state within a short period of time, the prime mover is driven again in response to the intake port detection sensor shifting from the second state to the first state even if the operation detection sensor does not shift from the ON state to the OFF state after the prime mover was stopped in response to the intake port detection sensor having shifted from the first state to the second state. This configuration can maintain user convenience while preventing the prime mover from being driven unexpectedly.

In one or more embodiments, the control unit may be configured, in case a signal from the operation detection sensor changes from indicating one of the ON state and the OFF state to indicating another of the ON state and the OFF state and keeps indicating the other of the ON state and the OFF state over a predetermined operation determination period, to determine that the operation detection sensor has shifted from the one of the ON state and the OFF state to the other of the ON state and the OFF state; and in case a signal from the intake port detection sensor changes from indicating one of the first state and the second state to indicating another of the first state and the second state and keeps indicating the other of the first state and the second state over a predetermined detection determination period, to determine that the intake port detection sensor has shifted from the one of the first state and the second state to the other of the first state and the second state. The detection determination period may be shorter than the operation determination period.

With the configuration above, the control unit can promptly recognize that the intake port detection sensor has shifted from one of the first state and the second state to the other of the first state and the second state.

In one or more embodiments, the control unit may be configured to stop the prime mover in a first manner in case the operation detection sensor shifts from the ON state to the OFF state while the intake port detection sensor is in the first state; and to stop the prime mover in a second manner in case the intake port detection sensor shifts from the first state to the second state while the operation detection sensor is in the ON state. A period required for the prime mover to stop in the second manner may be shorter than a period required for the prime mover to stop in the first manner.

With the configuration above, the prime mover is stopped gradually in response to the operation detection sensor shifting from the ON state to the OFF state, that is, in response to an operation on the operation member being released, which improves user operability. Further, with the configuration above, the prime mover is stopped promptly in response to the intake port detection sensor shifting from the first state to the second state, that is, in response to the intake port attachment member being detached from the intake port, which ensures user safety.

In one or more embodiments, the prime mover may comprise an electric motor. The control unit stopping the electric motor in the first manner may comprise the control unit stopping the electric motor by freewheeling. The control unit stopping the electric motor in the second manner may comprise the control unit stopping the electric motor by a three‑phase short‑circuit brake.

With the configuration above, the prime mover is stopped gradually in response to the operation detection sensor shifting from the ON state to the OFF state, that is, in response to an operation on the operation member being released, which improves user operability. Further, with the configuration above, the prime mover is stopped promptly in response to the intake port detection sensor shifting from the first state to the second state, that is, in response to the intake port attachment member being detached from the intake port, which ensures user safety.

The blower may further comprise an exhaust port through which air flows out due to rotation of the fan; an exhaust port attachment member detachably attachable to the exhaust port; and an exhaust port detection sensor configured to be in a third state when the exhaust port attachment member is attached to the exhaust port and be in a fourth state when the exhaust port attachment member is not attached to the exhaust port. The control unit may be configured to drive the prime mover in case the intake port detection sensor is in the first state, the exhaust port detection sensor is in the third state, and the operation detection sensor is in the ON state; to stop the prime mover in case the intake port detection sensor is in the first state, the exhaust port detection sensor is in the third state, and the operation detection sensor is in the OFF state; and to stop the prime mover in case the intake port detection sensor shifts from the first state to the second state while the operation detection sensor is in the ON state or in case the exhaust port detection sensor shifts from the third state to the fourth state while the operation detection sensor is in the ON state, and thereafter, to prohibit driving the prime mover until the operation detection sensor shifts from the ON state to the OFF state.

The above configuration stops the prime mover when the intake port attachment member or the exhaust port attachment member is detached from the intake port or the exhaust port while the operation detection sensor is in the ON state, and prohibits driving the prime mover until the operation detection sensor subsequently shifts from the ON state to the OFF state. Therefore, if a user has forgotten that the operation detection sensor is still in the ON state after the prime mover was stopped in response to the detachment of the intake port attachment member or the exhaust port attachment member from the intake port or the exhaust port and attaches the intake port attachment member or the exhaust port attachment member to the intake port or the exhaust port, the prime mover will not be driven. The above configuration thus prevents the prime mover from being driven unexpectedly.

In one or more embodiments, a blower may comprise a fan; a prime mover configured to rotate the fan; a detachable attachment member; an attachment detection sensor configured to be in a first state when the attachment member is attached and be in a second state when the attachment member is not attached; an operation member configured to receive an operation for rotating the fan; an operation detection sensor configured to detect whether the operation is performed on the operation member or not; and a control unit configured to control the prime mover. The control unit may be configured to drive the prime mover in case the attachment detection sensor is in the first state and the operation detection sensor is in an ON state; to stop the prime mover in case the attachment detection sensor is in the first state and the operation detection sensor is in an OFF state; and to stop the prime mover in case the attachment detection sensor shifts from the first state to the second state while the operation detection sensor is in the ON state, and thereafter, to prohibit driving the prime mover until the operation detection sensor shifts from the ON state to the OFF state.

In one or more embodiments, the attachment member may be detachably attachable to a flow passage through which air flows due to rotation of the fan.

With the configuration above, in the blower comprising the attachment member detachably attachable to the flow passage through which air flows due to the rotation of the fan, the prime mover can be suppressed from being driven unexpectedly.

In one or more embodiments, the control unit may be configured to stop the prime mover in case the attachment detection sensor shifts from the first state to the second state while the operation detection sensor is in the ON state; not to prohibit driving the prime mover until a predetermined period elapses since the prime mover was stopped; and after the predetermined period has elapsed from when the prime mover was stopped, to prohibit driving the prime mover until the operation detection sensor shifts from the ON state to the OFF state.

The attachment detection sensor may repeatedly shift between the first state and the second state within a short period of time, for example, due to chattering. If the prime mover is prohibited from being driven until the operation detection sensor shifts from the ON state to the OFF state in such a case after the prime mover was stopped in response to the attachment detection sensor having shifted from the first state to the second state, user convenience may be impaired. According to the configuration above, in such a case where the attachment detection sensor repeatedly shifts between the first state and the second state within a short period of time, the prime mover is driven again in response to the attachment detection sensor shifting from the second state to the first state even if the operation detection sensor does not shift from the ON state to the OFF state after the prime mover was stopped in response to the attachment detection sensor having shifted from the first state to the second state. This configuration can maintain user convenience while preventing the prime mover from being driven unexpectedly.

In one or more embodiments, the control unit may be configured, in case a signal from the operation detection sensor changes from indicating one of the ON state and the OFF state to indicating another of the ON state and the OFF state and keeps indicating the other of the ON state and the OFF state over a predetermined operation determination period, to determine that the operation detection sensor has shifted from the one of the ON state and the OFF state to the other of the ON state and the OFF state; and in case a signal from the attachment detection sensor changes from indicating one of the first state and the second state to indicating another of the first state and the second state and keeps indicating the other of the first state and the second state over a predetermined detection determination period, to determine that the attachment detection sensor has shifted from the one of the first state and the second state to the other of the first state and the second state. The detection determination period may be shorter than the operation determination period.

With the configuration above, the control unit can promptly recognize that the attachment detection sensor has shifted from one of the first state and the second state to the other of the first state and the second state.

In one or more embodiments, the control unit may be configured to stop the prime mover in a first manner in case the operation detection sensor shifts from the ON state to the OFF state while the attachment detection sensor is in the first state; and to stop the prime mover in a second manner in case the attachment detection sensor shifts from the first state to the second state while the operation detection sensor is in the ON state. A period required for the prime mover to stop in the second manner may be shorter than a period required for the prime mover to stop in the first manner.

With the configuration above, the prime mover is stopped gradually in response to the operation detection sensor shifting from the ON state to the OFF state, that is, in response to an operation on the operation member being released, which improves user operability. Further, with the configuration above, the prime mover is stopped promptly in response to the attachment detection sensor shifting from the first state to the second state, that is, in response to the attachment member being detached, which ensures user safety.

In one or more embodiments, the prime mover may comprise an electric motor. The control unit stopping the electric motor in the first manner may comprise the control unit stopping the electric motor by weak braking. The control unit stopping the electric motor in the second manner may comprise the control unit stopping the electric motor by strong braking. A braking force of the strong braking may be greater than a braking force of the weak braking. The braking force of the weak braking may be greater than a braking force acting when the electric motor is stopped by freewheeling.

With the configuration above, the electric motor is stopped gradually in response to the operation detection sensor shifting from the ON state to the OFF state, that is, in response to an operation on the operation member being released, which improves user operability. Further, with the configuration above, the electric motor is stopped promptly in response to the attachment detection sensor shifting from the first state to the second state, that is, in response to the attachment member being detached, which ensures user safety.

In one or more embodiments, a blower may comprise a fan; a prime mover configured to rotate the fan; a detachable attachment member; an attachment detection sensor configured to be in a first state when the attachment member is attached and be in a second state when the attachment member is not attached; an operation member configured to receive an operation for rotating the fan; an operation detection sensor configured to detect whether the operation is performed on the operation member or not; and a control unit configured to control the prime mover. The control unit may be configured to drive the prime mover in case the attachment detection sensor is in the first state and the operation detection sensor is in an ON state; to stop the prime mover in case the attachment detection sensor is in the first state and the operation detection sensor is in an OFF state; to stop the prime mover in a first manner in case the operation detection sensor shifts from the ON state to the OFF state while the attachment detection sensor is in the first state; and to stop the prime mover in a second manner in case the attachment detection sensor shifts from the first state to the second state while the operation detection sensor is in the ON state. A period required for the prime mover to stop in the second manner may be shorter than a period required for the prime mover to stop in the first manner.

In one or more embodiments, the attachment member may be detachably attachable to a flow passage through which air flows due to rotation of the fan.

In one or more embodiments, the prime mover may comprise an electric motor. The control unit stopping the electric motor in the first manner may comprise the control unit stopping the electric motor by weak braking. The control unit stopping the electric motor in the second manner may comprise the control unit stopping the electric motor by strong braking. A braking force of the strong braking may be greater than a braking force of the weak braking. The braking force of the weak braking may be greater than a braking force acting when the electric motor is stopped by freewheeling.

(First Embodiment) A blower 2 illustrated in FIG. 1 is a hand-held working machine that can be gripped and used with one or both hands by a user.

(Configuration of Blower 2) As illustrated in FIG. 2, the blower 2 comprises a housing 4, a fan 6, an electric motor 8 (see FIG. 5), a control unit 10 (see FIG. 6), a battery pack 12, an intake port 14, an exhaust port 16, an intake port cover 18, a trigger lever 20, a control lever 22 (see FIG. 1), a main power button 24 (see FIG. 1), a main power indication lamp 26a (see FIG. 1), and a mode indication lamp 26b (see FIG. 1). As illustrated in FIG. 3, the blower 2 can be used with the intake port cover 18 for the intake port 14 closed and a blow nozzle 28 attached to the exhaust port 16, to perform a blow operation of blowing air out from a distal end portion 28a of the blow nozzle 28 to blow off debris such as fallen leaves. As illustrated in FIG. 4, the blower 2 can also be used with the intake port cover 18 for the intake port 14 opened, a suction nozzle 30 attached to the intake port 14, and a dust bag 34 attached to the exhaust port 16 via a bent pipe 32, to perform a suction operation of suctioning air from a distal end portion 30a of the suction nozzle 30 to suction and collect debris such as fallen leaves into the dust bag 34. In the following description, an air flow direction in the exhaust port 16 is termed a front direction (or forward), and the opposite direction to the front direction is termed a rear direction (or rearward). Further, an air flow direction in the intake port 14 is termed a left direction (or leftward), and the opposite direction to the left direction is termed a right direction (or rightward). Moreover, a direction perpendicular to the front-rear direction and the right-left direction is termed an up-down direction.

As illustrated in FIG. 5, the housing 4 comprises a fan housing portion 36 for housing the fan 6, a volute portion 38 that is located radially outward of the fan housing portion 36 so as to surround the fan housing portion 36 and is in communication with the fan housing portion 36 along the entire circumference, a motor housing 40 for housing the electric motor 8, a control unit housing 42 for housing the control unit 10 (see FIG. 6), a handle portion 44 located above the volute portion 38, and a foot portion 46 located below the volute portion 38. As illustrated in FIG. 1, the handle portion 44 comprises a main grip 48 configured to be gripped with one hand of the user. The trigger lever 20, the control lever 22, the main power button 24, the main power indication lamp 26a, and the mode indication lamp 26b are located near the upper end of the main grip 48. The foot portion 46 comprises a sub-grip 50 configured to be gripped with the other hand of the user and a ground-contacting portion 52 configured to contact the ground when the blower 2 is placed on the ground. As illustrated in FIG. 4, a shoulder strap 53 can be attached to front and rear ends of the handle portion 44, and the user can hold the blower 2 via the shoulder strap 53 on a shoulder.

As illustrated in FIG. 2, the intake port 14 provides communication between the outside of the blower 2 and the inside of the fan housing portion 36. The intake port 14 is substantially coaxial with a rotation axis of the fan 6 housed in the fan housing portion 36. As illustrated in FIG. 5, the internal space in the fan housing portion 36 is in communication with the internal space in the motor housing 40 through a motor exhaust port 54. Further, as illustrated in FIG. 6, a motor intake port 56 is formed in a left end portion of the motor housing 40, and the motor intake port 56 provides communication between the outside and inside of the motor housing 40.

As illustrated in FIG. 5, the fan 6 comprises a base 6a having a circular plate shape, a first fan 6b projecting rightward from the right surface of the base 6a, and a second fan 6c projecting leftward from the left surface of the base 6a. The first fan 6b and the second fan 6c both function as centrifugal fans. The electric motor 8 is a so-called inner-rotor brushless motor. The electric motor 8 comprises an output shaft 8a rotatably supported by the housing 4 and fixed to the fan 6, a rotor 8c fixed to the output shaft 8a and comprising a permanent magnet 8b, a stator 8e located radially outward of the rotor 8c, fixed to the motor housing 40, and having coils 8d wound thereon, and Hall sensors 8f located leftward of the rotor 8c, fixed to the stator 8e, and configured to detect a rotation angle of the rotor 8c by detecting a magnetic change of the rotor 8c. When the electric motor 8 is driven, the output shaft 8a is thereby rotated, thereby rotating the fan 6.

When the fan 6 is rotated by driving the electric motor 8, air is drawn into the fan housing portion 36 through intake port 14 by the first fan 6b, and the air is ejected radially outward from the radially inner side toward radially outer side of the first fan 6b so that the air flows from the fan housing portion 36 into the volute portion 38. Further, when the fan 6 is rotated, air is drawn into the fan housing portion 36 through the motor exhaust port 54 by the second fan 6c, and the air is ejected radially outward from the radially inner side toward radially outer side of the second fan 6c so that the air flows from the fan housing portion 36 into the volute portion 38. During the above, air is drawn into the motor housing 40 through the motor intake port 56 and the air in the motor housing 40 flows into the fan housing portion 36 through the motor exhaust port 54. This air flow in the motor housing 40 cools components such as the permanent magnet 8b, the rotor 8c, the coils 8d, and the stator 8e of the electric motor 8. After ejected radially outward by the first fan 6b and the second fan 6c, the air flows along an inner surface of a radially outward portion of the volute portion 38 and then is discharged forward from the exhaust port 16 (see FIG. 2). As illustrated in FIG. 2, a blade 58 is attached to the right surface of the fan 6, and the blade 58 breaks fallen leaves suctioned through the intake port 14 into small pieces.

As illustrated in FIG. 5, the housing 4 comprises a left housing 60 forming left portions of the fan housing portion 36 and the volute portion 38, a right housing 62 forming right portions of the volute portion 38 and the handle portion 44, and a handle housing 64 forming a left portion of the handle portion 44.

As illustrated in FIG. 2, a battery pack attachment part 65 is located on the front surface of the housing 4 below the exhaust port 16. The battery pack 12 is detachably attached to the battery pack attachment part 65. The battery pack 12 comprises secondary battery cells 12a (see FIG. 9) such as lithium-ion battery cells. The battery pack 12 is capable of discharging electric current to an electric device such as the blower 2 when attached thereto and is also rechargeable by a charger (not illustrated) when attached thereto. The battery pack 12 is attached to the battery pack attachment part 65 by being slid rightward and is detached from the battery pack attachment part 65 by being slid leftward.

As illustrated in FIG. 7, the trigger lever 20 is pivotably supported by the handle portion 44 about a pivot axis 20a extending in the right-left direction. The trigger lever 20 comprises an operation portion 20b, a detection portion 20c, and an engagement portion 20d. The operation portion 20b projects downward from the lower surface of a front portion of the main grip 48. The detection portion 20c is arranged to face a trigger switch 66 located within the handle portion 44 substantially in the up-down direction. When the user pulls the operation portion 20b upward, the trigger lever 20 is thereby pivoted about the pivot axis 20a and the detection portion 20c pushes the trigger switch 66 downward. The trigger switch 66 is electrically connected to the control unit 10 and outputs an on/off signal and a push displacement signal to the control unit 10. The on/off signal indicates OFF when the trigger switch 66 is not pushed by the detection portion 20c, while it indicates ON when the trigger switch 66 is being pushed by the detection portion 20c. The push displacement signal indicates a displacement of the trigger switch 66 resulted from pushing by the detection portion 20c. When the trigger switch 66 is pushed by the user’s pulling operation on the operation portion 20b, the control unit 10 supplies electric power to the electric motor 8 from the battery pack 12 to rotate the fan 6. The control unit 10 changes the rotational speed of the electric motor 8 according to the displacement of the trigger switch 66. The trigger lever 20 is biased by a torsion spring 68 such that the operation portion 20b pivots downward. When the user releases the operation portion 20b, the biasing force of the torsion spring 68 causes the trigger lever 20 to pivot about the pivot axis 20a, thereby causing the detection portion 20c to separate from the trigger switch 66. In response, the control unit 10 stops the electric power supply from the battery pack 12 to the electric motor 8 to stop the rotation of the fan 6. In this case, the electric motor 8 continues to rotate for a while due to inertia before it stops. Herein, this stopping manner of the electric motor 8 is also referred to as stop by freewheeling.

The control lever 22 is pivotably supported by the handle portion 44 about a pivot axis 22a extending in the right-left direction. The pivot axis 22a is located upward and rearward of the pivot axis 20a. The control lever 22 comprises an operation portion 22b and an engagement portion 22c. As illustrated in FIG. 6, the operation portion 22b is located in an outer portion of the handle portion 44 along the left and upper surfaces of the handle portion 44. As illustrated in FIG. 7, the engagement portion 22c is located within the handle portion 44 and arranged to face the engagement portion 20d of the trigger lever 20 in the front-rear direction. When the user moves the operation portion 22b of the control lever 22 forward, the control lever 22 is thereby pivoted about the pivot axis 22a and the engagement portion 22c pushes the engagement portion 20d of the trigger lever 20 forward. Thereby, the trigger lever 20 is pivoted about the pivot axis 20a and the detection portion 20c pushes the trigger switch 66. Even when the user releases the control lever 22 after pivoting it to a desired pivot angle, the control lever 22 is maintained at the pivot angle because a cushion (not illustrated) applies a large friction force on the control lever 22. Thus, even when the user releases the control lever 22 after the trigger switch 66 has been pushed by pivoting the control lever 22, the trigger switch 66 is maintained in the pushed state and the fan 6 continues to be rotated by the electric motor 8. In contrast, when the user pivots the control lever 22 in the opposite direction, the biasing force of the torsion spring 68 causes the trigger lever 20 to pivot about the pivot axis 20a, and the detection portion 20c is thereby separated from the trigger switch 66, causing the rotation of the fan 6 by the electric motor 8 to stop.

The main power button 24 illustrated in FIG. 1 receives an operation of turning the main power of the blower 2 on/off and an operation of switching operation mode of the blower 2. The main power indication lamp 26a indicates whether the main power of the blower 2 is on or off. The mode indication lamp 26b indicates an operation mode of the blower 2. When the main power of the blower 2 is off, the main power indication lamp 26a and the mode indication lamp 26b are off. When the user pushes the main power button 24, the main power of the blower 2 is turned on and the main power indication lamp 26a is turned on. At this time, the operation mode of the blower 2 is set to a blow operation mode for the blow operation and the mode indication lamp 26b is also turned on. Subsequently, when the user pushes the main power button 24 again, the operation mode of the blower 2 switches to a suction operation mode for the suction operation with the main power of the blower 2 remaining on, and the mode indication lamp 26b is turned off with the main power indication lamp 26a remaining on. Subsequently, when the user pushes the main power button 24 once again, the operation mode of the blower 2 switches to the blow operation mode with the main power of the blower 2 remaining on, and the mode indication lamp 26b is turned on with the main power indication lamp 26a remaining on. When the user pushes and holds the main power button 24 for a while (e.g., for two seconds) while the main power of the blower 2 is on, the main power of the blower 2 is turned off and the main power indication lamp 26a and the mode indication lamp 26b are also turned off. The maximum rotational speed of the electric motor 8 (i.e., the rotational speed of the electric motor 8 when the trigger switch 66 is pushed to its maximum displacement) in the suction operation mode is less than the maximum rotational speed of the electric motor 8 in the blow operation mode.

As illustrated in FIG. 7, a first detection member 70, a compression spring 72, and a first detection switch 74 are housed within the handle portion 44. The first detection member 70 is supported by the handle portion 44 such that it is movable in the front-rear direction between a forward position and a rearward position. The compression spring 72 biases the first detection member 70 from the rearward position toward the forward position. The first detection switch 74 is electrically connected to the control unit 10 and outputs an on/off signal that indicates OFF when the first detection member 70 is at the forward position, while it indicates ON when the first detection member 70 is at the rearward position. The first detection switch 74 may be a contact detection sensor such as a mechanical microswitch or a non-contact detection sensor such as a magnetic sensor. As illustrated in FIG. 2, a through hole 16a is formed in a portion of the front surface of the handle portion 44 near the exhaust port 16. As illustrated in FIG. 7, the blow nozzle 28 and the bent pipe 32 each comprises a press portion 75 configured to enter the handle portion 44 through the through hole 16a when the blow nozzle 28 or the bent pipe 32 is attached to the exhaust port 16 and press the first detection member 70 rearward. When the blow nozzle 28 or the bent pipe 32 is attached to the exhaust port 16, the first detection member 70 is pressed by the press portion 75 to move from the forward position to the rearward position against the biasing force of the compression spring 72 and the first detection switch 74 outputs the on/off signal. When the blow nozzle 28 or the bent pipe 32 is detached from the exhaust port 16, the biasing force of the compression spring 72 causes the first detection member 70 to move from the rearward position to the forward position and the first detection switch 74 outputs the on/off signal.

As illustrated in FIG. 2, the intake port cover 18 comprises a plurality of intake holes 18a. The intake port cover 18 is pivotably supported by the right housing 62 about a pivot axis 18b substantially extending in the up-down direction. The intake port cover 18 is biased by a torsion spring 76 in a closing direction. The intake port cover 18 comprises a contact portion 18c and an engagement groove 18d. A lock lever 78 is located on the right housing 62. The lock lever 78 is pivotably supported by the right housing 62 about a pivot axis 78a extending in the right-left direction. The lock lever 78 comprises an operation portion 78b and an engagement portion 78c. The lock lever 78 is biased by a torsion spring (not illustrated) in a pivot direction that brings the engagement portion 78c rearward. When the intake port cover 18 is closed, the contact portion 18c contacts the engagement portion 78c and the lock lever 78 is thereby pivoted so that the engagement portion 78c is moved forward. Subsequently, once the contact portion 18c passes the engagement portion 78c, the biasing force of the torsion spring causes the lock lever 78 to pivot so that the engagement portion 78c is moved rearward. As a result, the engagement portion 78c enters and engages the engagement groove 18d, thereby maintaining the intake port cover 18 closed. Subsequently, when the user pushes the operation portion 78b rearward, the lock lever 78 is thereby pivoted so that the engagement portion 78c is moved forward, and the engagement portion 78c disengages from the engagement groove 18d. Subsequently, the user can pivot the intake port cover 18 against the biasing force of the torsion spring 76 to open the intake port cover 18. In the present embodiment, closing the intake port cover 18 is also referred to as attaching the intake port cover 18 to the intake port 14, and opening the intake port cover 18 is also referred to as detaching the intake port cover 18 from the intake port 14.

As illustrated in FIG. 8, a second detection member 80, a torsion spring 82, and a second detection switch 84 are located in the right housing 62. The second detection member 80, the torsion spring 82, and the second detection switch 84 are covered by a switch cover 86 (see FIG. 2). The second detection member 80 is supported by the right housing 62 such that it is pivotable between a forward angle and a rearward angle about a pivot axis 80a extending in the right-left direction. The torsion spring 82 biases the second detection member 80 from the forward angle toward the rearward angle. The second detection switch 84 is electrically connected to the control unit 10 and outputs an on/off signal that indicates OFF when the second detection member 80 is at the rearward angle, while it indicates ON when the second detection member 80 is at the forward angle. The second detection switch 84 may be a contact detection sensor such as a mechanical microswitch or a non-contact detection sensor such as a magnetic sensor. The intake port cover 18 and the suction nozzle 30 each comprises a press portion 88 configured to press the second detection member 80 from the rearward angle toward the forward angle when the intake port cover 18 or the suction nozzle 30 is attached to the intake port 14. When the intake port cover 18 or the suction nozzle 30 is attached to the intake port 14, the second detection member 80 is pressed by the press portion 88 to pivot from the rearward angle to the forward angle against the biasing force of the torsion spring 82 and the second detection switch 84 outputs the on/off signal. When the intake port cover 18 or the suction nozzle 30 is detached from the intake port 14, the biasing force of the torsion spring 82 causes the second detection member 80 to pivot from the forward angle to the rearward angle and the second detection switch 84 outputs the on/off signal.

As illustrated in FIG. 9, the control unit 10 comprises a power control unit 90, a main power FET 92, a regulator 94, an MCU 96, a gate driver 98, and an inverter circuit 100. The power control unit 90 controls the main power FET 92 and the regulator 94. The main power FET 92 is arranged on a power supply path through which electric power from the battery pack 12 is supplied to the inverter circuit 100. The power control unit 90 keeps the main power FET 92 conductive while the main power of the blower 2 is on and keeps the main power FET 92 non-conductive while the main power of the blower 2 is off. The regulator 94 decreases the voltage from the battery pack 12 and supplies it to the MCU 96, etc. The MCU 96 controls the inverter circuit 100 via the gate driver 98. The inverter circuit 100 comprises six motor drive FETs 100a, 100b, 100c, 100d, 100e, 100f. The coils 8d of the electric motor 8 comprise a U-phase terminal 8g, a V-phase terminal 8h, and a W-phase terminal 8i. The motor drive FET 100a connects the power supply potential to the U-phase terminal 8g of the electric motor 8, the motor drive FET 100b connects the power supply potential to the V-phase terminal 8h of the electric motor 8, the motor drive FET 100c connects the power supply potential to the W-phase terminal 8i of the electric motor 8, the motor drive FET 100d connects the ground potential to the U-phase terminal 8g of the electric motor 8, the motor drive FET 100e connects the ground potential to the V-phase terminal 8h of the electric motor 8, and the motor drive FET 100f connects the ground potential to the W-phase terminal 8i of the electric motor 8. The power supply potential is connected to the positive potential of the battery pack 12 via the main power FET 92. The ground potential is connected to the negative potential of the battery pack 12. Detection signals from the Hall sensors 8f of the electric motor 8 are input to the MCU 96. The MCU 96 controls electric power supplied to the electric motor 8 via the U-phase terminal 8g, the V-phase terminal 8h, and the W-phase terminal 8i by switching each of the motor drive FETs 100a, 100b, 100c, 100d, 100e, 100f between being conductive and non-conductive based on the detection signals from the Hall sensors 8f, thereby controlling the electric motor 8. The control unit 10 can suddenly stop the electric motor 8 by making all of the motor drive FETs 100a, 100b, 100c non-conductive and making all of the motor drive FETs 100d, 100e, 100f conductive while the electric motor 8 is rotating. Herein, this stopping manner of the electric motor 8 is also referred to as stop by three-phase short-circuit brake.

(Exemplary Process Performed by Control Unit 10) Hereinafter, a process performed by the control unit 10 is described with reference to FIG. 10. The control unit 10 starts the process illustrated in FIG. 10 in response to electric power being supplied to the control unit 10 after the main power of the blower 2 was turned on. At the start of the process illustrated in FIG. 10, the trigger switch 66, the first detection switch 74, and the second detection switch 84 are each in OFF state. Further, an abnormality determination flag indicates off.

In S2, the control unit 10 determines whether the trigger switch 66 is in an ON state or OFF state. The control unit 10 determines that the trigger switch 66 has shifted from the ON state to the OFF state in case the on/off signal from the trigger switch 66 changes from indicating the ON state to indicating the OFF state while the trigger switch 66 is determined to be in the ON state and keeps indicating the OFF state for a predetermined period (e.g., 20 ms). Further, the control unit 10 determines that the trigger switch 66 has shifted from the OFF state to the ON state in case the on/off signal from the trigger switch 66 changes from indicating the OFF state to indicating the ON state while the trigger switch 66 is determined to be in the OFF state and keeps indicating the ON state for a predetermined period (e.g., 20 ms).

In S4, the control unit 10 determines whether the first detection switch 74 is in an ON state or OFF state. The control unit 10 determines that the first detection switch 74 has shifted from the ON state to the OFF state in case the on/off signal from the first detection switch 74 changes from indicating the ON state to indicating the OFF state while the first detection switch 74 is determined to be in the ON state and keeps indicating the OFF state for a predetermined period (e.g., 0.1 ms). Further, the control unit 10 determines that the first detection switch 74 has shifted from the OFF state to the ON state in case the on/off signal from the first detection switch 74 changes from indicating the OFF state to indicating the ON state while the first detection switch 74 is determined to be in the OFF state and keeps indicating the ON state for a predetermined period (e.g., 0.1 ms).

In S6, the control unit 10 determines whether the second detection switch 84 is in an ON state or OFF state. The control unit 10 determines that the second detection switch 84 has shifted from the ON state to the OFF state in case the on/off signal from the second detection switch 84 changes from indicating the ON state to indicating the OFF state while the second detection switch 84 is determined to be in the ON state and keeps indicating the OFF state for a predetermined period (e.g., 0.1 ms). Further, the control unit 10 determines that the second detection switch 84 has shifted from the OFF state to the ON state in case the on/off signal from the second detection switch 84 changes from indicating the OFF state to indicating the ON state while the second detection switch 84 is determined to be in the OFF state and keeps indicating the ON state for a predetermined period (e.g., 0.1 ms).

In S8, the control unit 10 determines whether the abnormality determination flag indicates ON or not. In case the abnormality determination flag indicates OFF (NO in S8), the flow proceeds to S10.

In S10, the control unit 10 determines whether the first detection switch 74 is in the ON state or not. In case the first detection switch 74 is in the ON state (YES in S10), the flow proceeds to S12.

In S12, the control unit 10 determines whether the second detection switch 84 is in the ON state or not. In case the second detection switch 84 is in the ON state (YES in S12), the flow proceeds to S16.

In case the first detection switch 74 is in the OFF state in S10 (NO in S10) or the second detection switch 84 is in the OFF state in S12 (NO in S12), the flow proceeds to S14. In S14, the control unit 10 changes the abnormality determination flag to ON. After S14, the flow proceeds to S16.

In S16, the control unit 10 determines whether the abnormality determination flag indicates ON or not. In case the abnormality determination flag indicates OFF (NO in S16), the flow proceeds to S18.

In S18, the control unit 10 determines whether the trigger switch 66 is in the ON state or not. In case the trigger switch 66 is in the ON state (YES in S18), the flow proceeds to S20. In S20, the control unit 10 drives the electric motor 8. At this time, the control unit 10 adjusts the rotational speed of the electric motor 8 according to the current operation mode and the displacement of the trigger switch 66. After S20, the flow returns to S2.

In case the trigger switch 66 is in the OFF state in S18 (NO in S18), the flow proceeds to S22. In S22, the control unit 10 stops the electric motor 8 by freewheeling. After S22, the flow returns to S2.

In case the abnormality determination flag indicates ON in S16 (YES in S16), the flow proceeds to S24. In S24, the control unit 10 stops the electric motor 8 by the three-phase short-circuit brake. After S24, the flow returns to S2.

In case the abnormality determination flag indicates ON in S8 (YES in S8), the flow proceeds to S26. In S26, the control unit 10 determines whether the trigger switch 66 is in the OFF state or not. In case the trigger switch 66 is in the ON state (NO in S26), the flow proceeds to S16. In case the trigger switch 66 is in the OFF state (YES in S26), the flow proceeds to S27. In S27, the control unit 10 determines whether the electric motor 8 is completely stopped or not. In case the electric motor 8 is not completely stopped (NO in S27), the flow proceeds to S16. In case the electric motor 8 is completely stopped (YES in S27), the flow proceeds to S28. In S28, the control unit 10 changes the abnormality determination flag to OFF. After S28, the flow proceeds to S16.

In the process illustrated in FIG. 10, in case the trigger switch 66 is in the OFF state and both the first detection switch 74 and the second detection switch 84 are in the ON state after the main power of the blower 2 was turned on, the abnormality determination flag indicates OFF in S16 (see S8, S10, S12). Therefore, when the trigger switch 66 shifts from the OFF state to the ON state while both the first detection switch 74 and the second detection switch 84 are in the ON state, the control unit 10 drives the electric motor 8 (see S16, S18, S20). Further, when the trigger switch 66 shifts from the ON state to the OFF state while both the first detection switch 74 and the second detection switch 84 are in the ON state, the control unit 10 stops the electric motor 8 by freewheeling (see S16, S18, S22). Thereby, the electric motor 8 is gradually stopped.

When the first detection switch 74 and/or the second detection switch 84 shift(s) from the ON state to the OFF state while the trigger switch 66 is in the ON state after the control unit 10 started driving the electric motor 8 in S20, the abnormal determination flag is changed from OFF to ON (see S8, S10, S12, S14). In this case, the control unit 10 stops the electric motor 8 by the three-phase short-circuit brake (see S16, S24). Thereby, the electric motor 8 is promptly stopped. Thereafter, regardless of whether the first detection switch 74 and/or the second detection switch 84 are/is in the ON state or the OFF state, the abnormal determination flag is maintained ON (see S8, S26) and the electric motor 8 is prohibited from being driven (see S16, S24) until the trigger switch 66 shifts from the ON state to the OFF state. When the trigger switch 66 shifts from the ON state to the OFF state, the abnormality determination flag changes from ON to OFF (see S8, S26, S27, S28) and the prohibition on driving the electric motor 8 is released (see S16, S18, S20).

During the control unit 10 stopping the electric motor 8 by freewheeling in S22, when the first detection switch 74 and/or the second detection switch 84 shift(s) from the ON state to the OFF state before the electric motor 8 is completely stopped, the abnormal determination flag changes from OFF to ON (see S8, S10, S12, S14). In this case, the electric motor 8 is promptly stopped since the control unit 10 stops the electric motor 8 by the three-phase short-circuit brake (see S16, S24).

(Another Exemplary Process Performed by Control Unit 10) The control unit 10 may perform the process illustrated in FIG. 11 instead of the process illustrated in FIG. 10. The process illustrated in FIG. 11 includes additional steps of S30, S32, S34, S36, S38, and S40 compared to the process illustrated in FIG. 10, but except for the additional steps, it is substantially the same as the process illustrated in FIG. 10. Hereinafter, differences of the process illustrated in FIG. 11 from the process illustrated in FIG. 10 are described.

In the process illustrated in FIG. 11, in case the abnormality determination flag indicates OFF in S8 (NO in S8), the flow proceeds to S30. In S30, the control unit 10 resets a count value. After S30, the flow proceeds to S10.

In case the abnormality determination flag indicates ON in S8 (YES in S8), the flow proceeds to S32. In S32, the control unit 10 increases the count value. After S32, the flow proceeds to S34.

In S34, the control unit 10 determines whether the count value exceeds a threshold or not. In case the count value exceeds the threshold (YES in S34) (i.e., in case a predetermined period has elapsed since the abnormality determination flag changed from OFF to ON in S14 after the count value had been reset in S30), the flow proceeds to S26. In case the count value is equal to or less than the threshold (NO in S34) (i.e., in case the predetermined period has not elapsed yet since the abnormality determination flag changed from OFF to ON in S14 after the count value had been reset in S30), the flow proceeds to S36.

In S36, the control unit 10 determines whether the first detection switch 74 is in the ON state or not. In case the first detection switch 74 is in the ON state (YES in S36), the flow proceeds to S38.

In S38, the control unit 10 determines whether the second detection switch 84 is in the ON state or not. In case the second detection switch 84 is in the ON state (YES in S38), the flow proceeds to S40.

In S40, the control unit 10 changes the abnormality determination flag to OFF. After S40, the flow proceeds to S16.

In case the first detection switch 74 is in the OFF state in S36 (NO in S36) or the second detection switch 84 is in the OFF state in S38 (NO in S38), the flow proceeds to S16.

In the process illustrated in FIG. 11, in case the first detection switch 74 and/or the second detection switch 84 shift(s) from the ON state to the OFF state while the trigger switch 66 is in the ON state after the control unit 10 started driving the electric motor 8 in S20, the abnormality determination flag is changed from OFF to ON (see S8, S30, S10, S12, S14). In this case, the control unit 10 stops the electric motor 8 by the three-phase short-circuit brake (see S16, S24). Thereby, the electric motor 8 is promptly stopped. In case both the first detection switch 74 and the second detection switch 84 shift to ON state before the predetermined period elapses from when the electric motor 8 was stopped by the three-phase short-circuit brake in S24, the abnormality determination flag is changed from ON to OFF (see S8, S32, S24, S36, S38, S40). In this case, the electric motor 8 is not prohibited from being driven, and thus the electric motor 8 is driven again when the trigger switch 66 shifts to the ON state (see S16, S18, S20). Once the predetermined period has elapsed from when the electric motor 8 was stopped by the three-phase short-circuit brake in S24, the abnormality determination flag is thereafter maintained ON (see S8, S34, S26) and the electric motor 8 is prohibited from being driven (see S16, S24) until the trigger switch 66 shifts from the ON state to the OFF state, regardless of whether the first detection switch 74 and/or the second detection switch 84 are/is in the ON state or OFF state. When the trigger switch 66 shifts from the ON state to the OFF state, the abnormality determination flag is changed from ON to OFF (see S8, S34, S26, S27, S28), thereby the prohibition on driving the electric motor 8 is released (see S16, S18, S20).

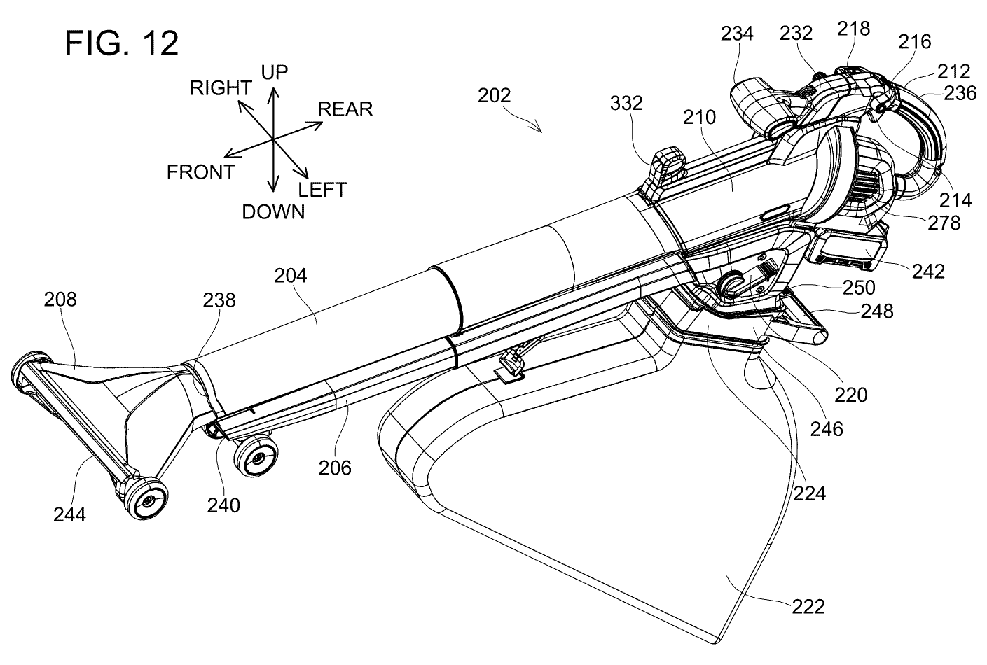

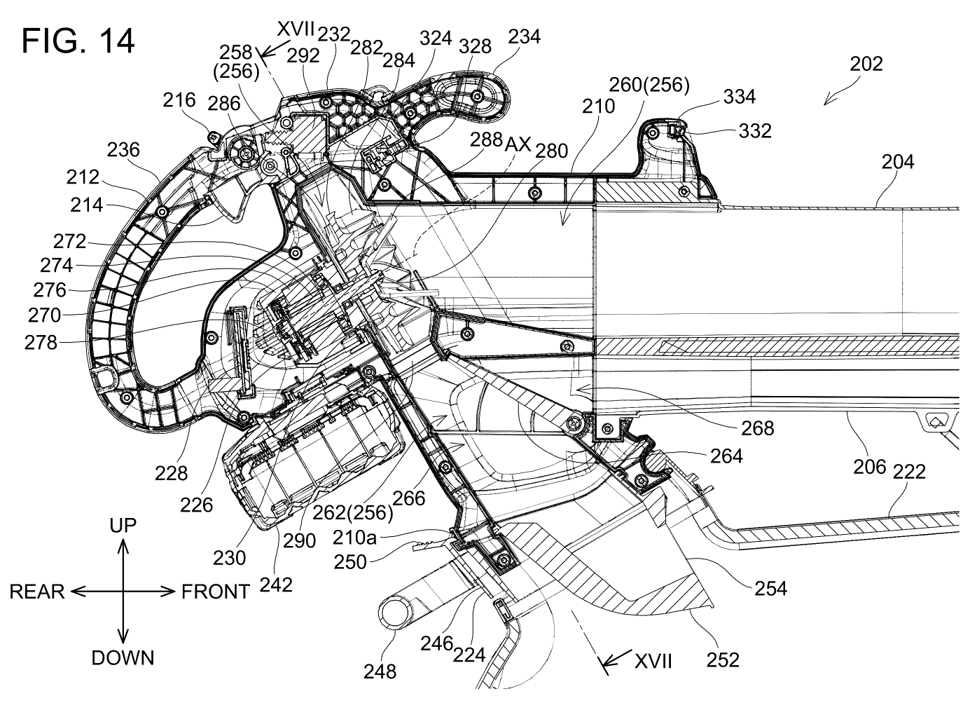

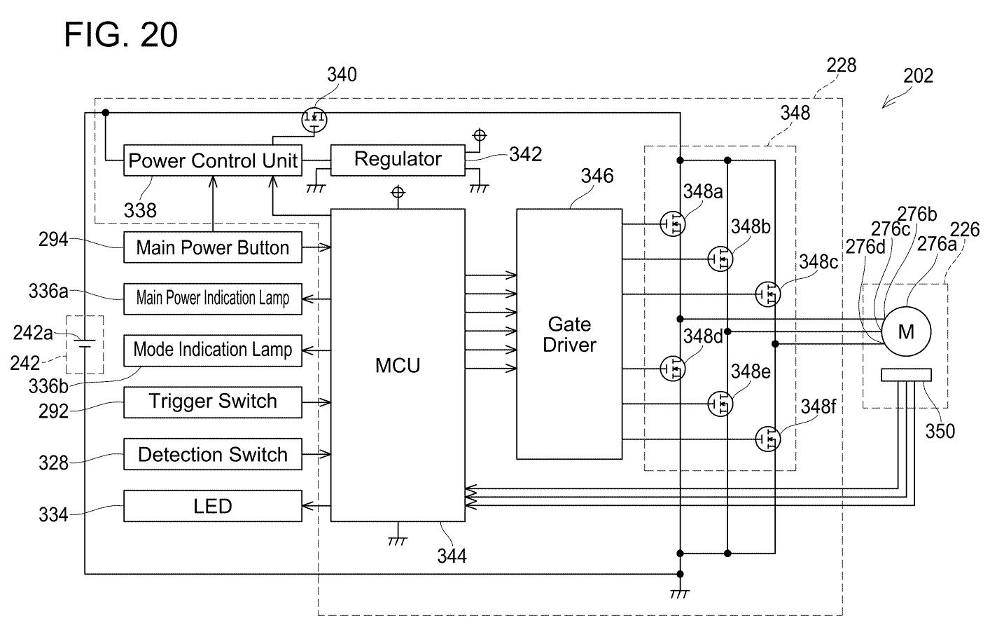

(Second Embodiment) As illustrated in FIG. 12, a blower 202 comprises an intake pipe 204, a discharge pipe 206, a suction nozzle 208, a housing 210, a handle 212, a trigger lever 214, a control lever 216, an operation panel 218, a switching lever 220, a collection bag 222, a connection member 224, an electric motor 226 (see FIG. 14), a control unit 228 (see FIG. 14), and a fan 230 (see FIG. 14). A battery pack 242 is detachably attached to a lower rear portion of the housing 210. The battery pack 242 comprises rechargeable secondary battery cells 242a (see FIG. 20) such as lithium-ion battery cells. The blower 202 drives the electric motor 226 using electric power supplied from the battery pack 242 to rotate the fan 230. The blower 202 uses an air flow generated by the rotation of the fan 230 for a suction operation of suctioning debris (e.g., fallen leaves) or a blow operation of blowing out air.

In the present embodiment, a direction from the housing 210 toward the intake pipe 204 along the longitudinal direction of the intake pipe 204 is termed a front direction (or forward), and the opposite direction is termed a rear direction (or rearward). Further, a direction perpendicular to the front-rear direction and from the housing 210 toward the collection bag 222 is termed a down direction (or downward), and the opposite direction is termed an up direction (or upward). Moreover, a direction perpendicular to the front-rear direction and the up-down direction and from the housing 210 toward the switching lever 220 is termed a left direction (or leftward), and the opposite direction is termed a right direction (or rightward).

The handle 212 comprises a base portion 232, a front grip portion 234, and a rear grip portion 236. The base portion 232 projects upward and rearward from the upper surface of the housing 210. The front grip portion 234 extends upward and forward from the front surface of the base portion 232 and then branches and extends rightward and leftward. The rear grip portion 236 extends rearward and downward from the rear surface of the base portion 232, bends and extend forward and downward, further bends and extends upward and forward, and then connects to the rear surface of the housing 210. The user can carry the blower 202 by gripping the front grip portion 234 with one hand and the rear grip portion 236 with the other hand.

The intake pipe 204 and the discharge pipe 206 are attached to a front portion of the housing 210. The intake pipe 204 and the discharge pipe 206 are fixed to each other and each extend in the front-rear direction. The intake pipe 204 is located above the discharge pipe 206. A first distal end opening 238 is formed in a distal end portion of the intake pipe 204, and the first distal end opening 238 provides communication between the inside and outside of the intake pipe 204. A second distal end opening 240 is formed in a distal end portion of the discharge pipe 206, and the second distal end opening 240 provides communication between the inside and outside of the discharge pipe 206.

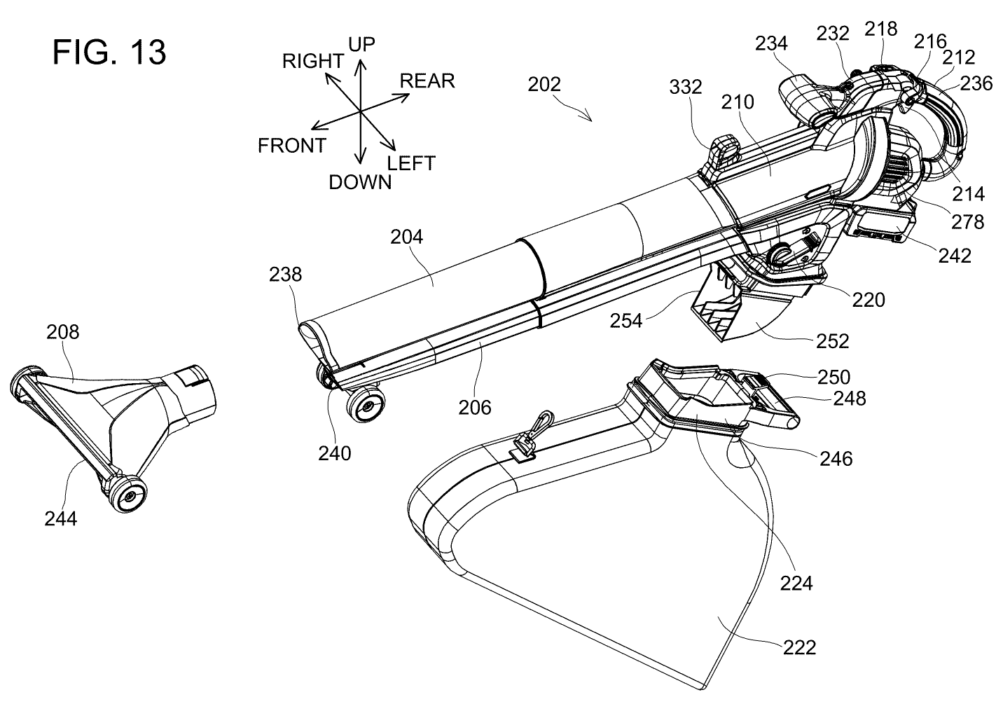

As illustrated in FIGS. 12 and 13, the suction nozzle 208 is detachably attached to the first distal end opening 238 of the intake pipe 204. In the state where the suction nozzle 208 is attached to the intake pipe 204 (i.e., the state illustrated in FIG. 12), the blower 202 suctions air through a suction opening 244 of the suction nozzle 208. In the state where the suction nozzle 208 is detached from the intake pipe 204 (i.e., the state illustrated in FIG. 13), the blower 202 suctions air through the first distal end opening 238.

As illustrated in FIGS. 12 and 13, the collection bag 222 is detachably attached to a lower portion of the housing 210 via the connection member 224. The connection member 224 comprises a connection frame 246, a handle 248, and an engagement piece 250. The collection bag 222 is connected to the connection frame 246. The handle 248 extends rearward from a left portion of the rear surface of the connection frame 246, bends and extends rightward, further bends and extends forward, and then connects to a right portion of the rear surface of the connection frame 246. The engagement piece 250 is located on a central portion of the rear surface of the connection frame 246. As illustrated in FIG. 12, when the connection member 224 is attached to the housing 210, the engagement piece 250 is engaged with a recess 210a (see FIG. 14) formed in the outer surface of the housing 210. The user can flex the engagement piece 250 in a direction away from the outer surface of the housing 210 by gripping the handle 248 with one hand and pushing the engagement piece 250 downward with the other hand. This operation disengages the engagement piece 250 from the housing 210, allowing detachment of the connection member 224 and the collection bag 222 from the housing 210. The collection bag 222 is formed of a mesh material. Therefore, air in the collection bag 222 can flow through the collection bag 222. Debris suctioned by the blower 202 is collected into the collection bag 222. A duct member 252 is attached to the lower portion of the housing 210. A discharge opening 254 is formed in the duct member 252, and debris suctioned by the blower 202 is discharged through the discharge opening 254. The discharge opening 254 is open forward and upward. Therefore, debris suctioned by the blower 202 is discharged from the discharge opening 254 toward a front portion of the collection bag 222.

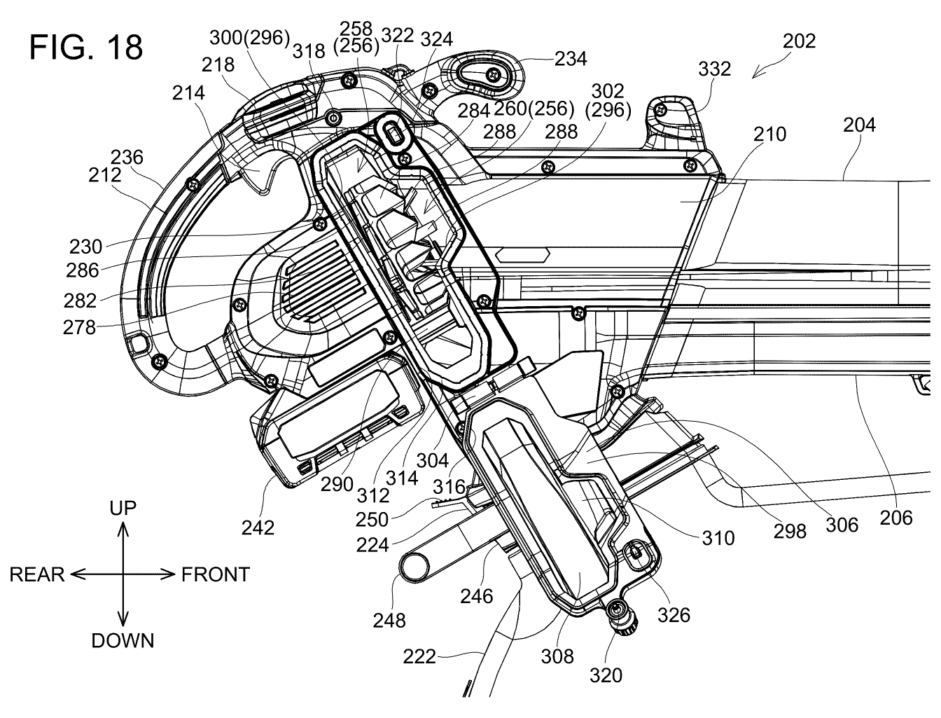

As illustrated in FIG. 14, the blower 202 further comprises a volute passage 258 in which the fan 230 is located, a suction passage 260 located forward of the volute passage 258, and a discharge passage 262 located downward and forward of the volute passage 258. The volute passage 258, the suction passage 260, and the discharge passage 262 are also referred to as “air passages 256”. The air passages 256 are formed between the housing 210 and a maintenance cover 298 (see FIG. 18).

The suction passage 260 extends forward as viewed from the volute passage 258. The front end of the suction passage 260 is connected to the rear end of the intake pipe 204. The suction passage 260 connects the volute passage 258 to the intake pipe 204.

The discharge passage 262 in sectioned by a switching piece 264 located within the discharge passage 262 into a first discharge passage 266 extending downward as viewed from the volute passage 258 and a second discharge passage 268 extending forward as viewed from the volute passage 258. The lower end of the first discharge passage 266 is connected to the upper end of the duct member 252. The front end of the second discharge passage 268 is connected to the rear end of the discharge pipe 206.

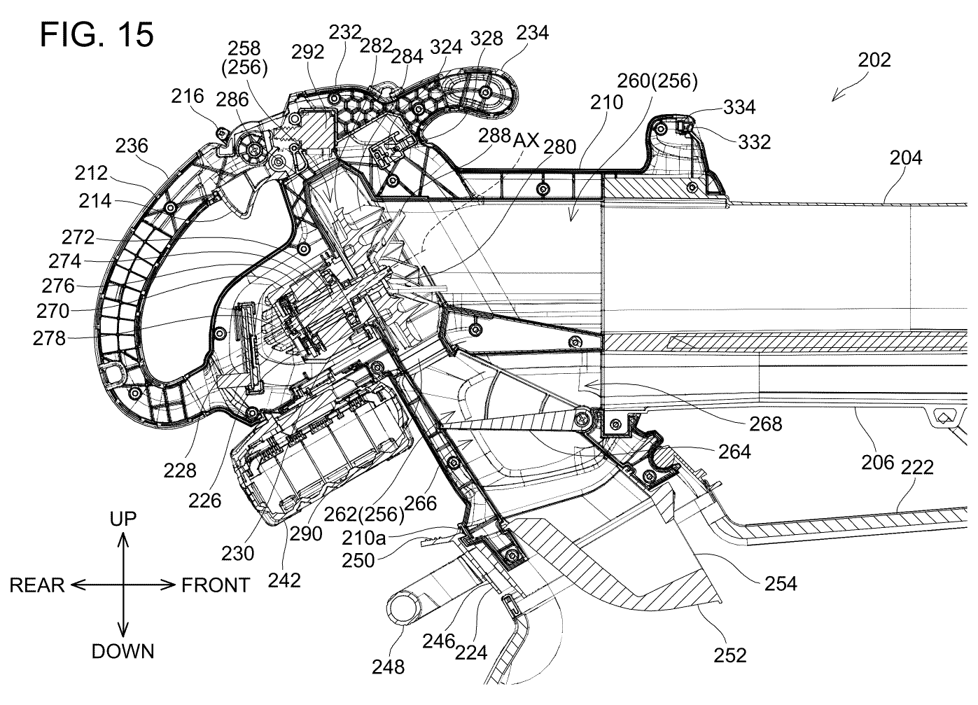

As illustrated in FIG. 14 and 15, the switching piece 264 is pivotable relative to the housing 210 about an axis extending in the right-left direction. The switching piece 264 works with the switching lever 220 (see FIG. 12) located on the outer surface of the handle 212. The user can move the switching piece 264 between a collection position illustrated in FIG. 14 and a non-collection position illustrated in FIG. 15 by operating the switching lever 220. As illustrated in FIG. 14, when the switching piece 264 is at the collection position, the volute passage 258 is in communication with the first discharge passage 266 and the volute passage 258 is not in communication with the second discharge passage 268. As illustrated in FIG. 15, when the switching piece 264 is at the non-collection position, the volute passage 258 is not in communication with the first discharge passage 266 and the volute passage 258 is in communication with the second discharge passage 268. Thus, the switching piece 264 is selectively switched between the state of providing communication between the volute passage 258 and the first discharge passage 266 (i.e., the state illustrated in FIG. 14) and the state of providing communication between the volute passage 258 and the second discharge passage 268 (i.e., the state illustrated in FIG. 15).

As illustrated in FIG. 14, a motor housing 270 is fixed to the rear wall of the volute passage 258, and the motor housing 270 supports the electric motor 226. The electric motor 226 comprises a motor shaft 272, a rotor 274 fixed to the motor shaft 272 and comprising a permanent magnet (not illustrated), a stator 276 located radially outward of the rotor 274 and having coils 276a (see FIG. 20) wound thereon, and Hall sensors 350 (see FIG. 20) configured to detect the rotational angle of the rotor 274 by detecting a magnetic change of the rotor 274. The electric motor 226 is a so-called inner-rotor brushless motor. The motor shaft 272 penetrates the front wall of the motor housing 270 and extends into the volute passage 258. The motor shaft 272 is coupled to the fan 230. The control unit 228 is located rearward of the electric motor 226. The control unit 228 supplies electric power from the battery pack 242 to the electric motor 226. The control unit 228 controls the output of the electric motor 226 by adjusting electric power supplied to the electric motor 226. A vent opening 278 is formed in the side wall of the housing 210, and the vent opening 278 is in communication with the space where the electric motor 226 and the control unit 228 are housed. The battery pack 242 is attached to the housing 210 by being slid forward and upward relative to the housing 210. The battery pack 242 is detached from the housing 210 be being slid rearward and downward relative to the housing 210.

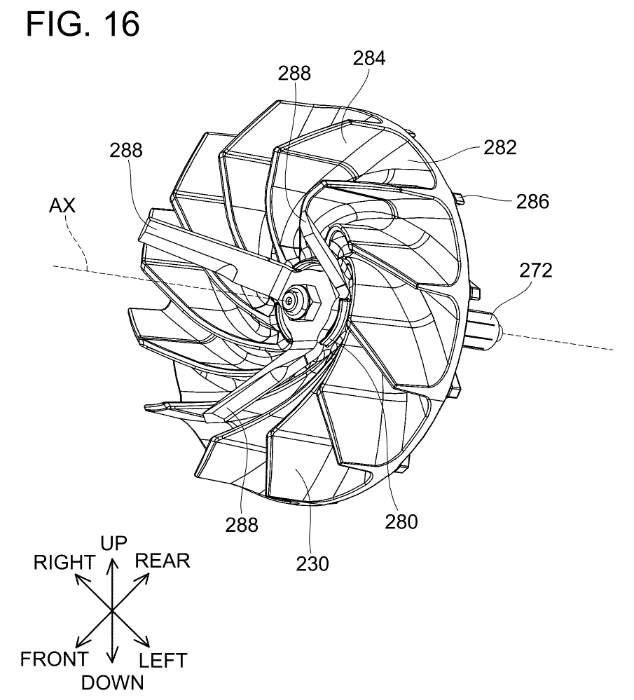

As illustrated in FIG. 16, the fan 230 comprises a shaft 280, a base 282, a first fan 284, and a second fan 286. The base 282 extends radially outward from the outer surface of the shaft 280. The first fan 284 projects forward from the front surface of the base 282. The second fan 286 projects rearward from the rear surface of the base 282. The shaft 280 is fixed to a front portion of the motor shaft 272. Therefore, the fan 230 integrally rotates with the motor shaft 272. A rotation axis AX of the fan 230 (which can be considered as the rotation axis of the motor shaft 272) is inclined to the front‑rear direction so as to slope upward toward the front. The inclination angle of the rotation axis AX to the front-rear direction is, for example, within a range from 20 degrees to 40 degrees, and in the present embodiment, it is 30 degrees. The first fan 284, when rotating, draws in air present in front of the fan 230 and ejects the air radially outward from the fan 230. Similarly, the second fan 286, when rotating, draws in air present behind the fan 230 and eject the air radially outward from the fan 230. That is, the first fan 284 and the second fan 286 both function as centrifugal fans. Metal blades 288 are fixed to the front end of the shaft 280. The blades 288 integrally rotate with the motor shaft 272. The blades 288 break debris suctioned by the blower 202 into small pieces by its rotation.

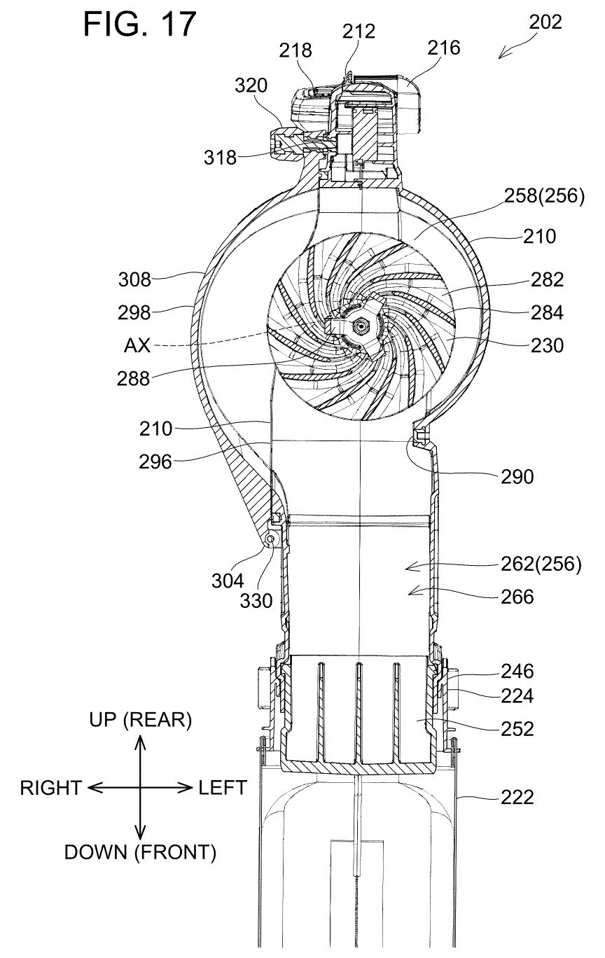

As illustrated in FIG. 17, the volute passage 258 has a volute shape. Specifically, the inner surface of the volute passage 258 spirally extends in the rotation direction of the fan 230 (which is the counterclockwise direction as viewed from the upper front side in the present embodiment) from a projection 290 projecting rightward from the left wall of the housing 210. The inner surface of the volute passage 258 guides the air ejected from the fan 230 into a space below the volute passage 258 (i.e., the discharge passage 262).

As illustrated in FIG. 14, the trigger lever 214 is located in a front portion of the lower surface of the rear grip portion 236. The user can operate the trigger lever 214 with the index finger of the hand gripping the rear grip portion 236. A trigger switch 292 is located within the base portion 232, and the trigger switch 292 is configured to be pushed by the trigger lever 214. The trigger switch 292 is electrically connected to the control unit 228 and outputs an on/off signal and a push displacement signal to the control unit 228. The on/off signal indicates OFF when the trigger switch 292 is not pushed by the trigger lever 214, while it indicates ON when the trigger switch 292 is being pushed by the trigger lever 214. The push displacement signal indicates a displacement of the trigger switch 292 resulted from pushing by the trigger lever 214. When the user pushes the trigger lever 214, electric power is supplied from the battery pack 242 to the electric motor 226 to drive the electric motor 226 and rotate the fan 230. Thereby, the blower 202 suctions or discharges air. The output of the electric motor 226 (i.e., the rotational speed of the fan 230) is adjusted according to the displacement of the trigger lever 214. When the user releases the trigger lever 214 so that the trigger lever 214 is not pushed any longer, the supply of electric power from the battery pack 242 to the electric motor 226 is stopped, and the air suction or discharge by the blower 202 is thus stopped.

The control lever 216 is located near the interface between the base portion 232 and the rear grip portion 236. The user can maintain the trigger lever 214 in a state of being pushed by a desired displacement by moving the control lever 216 to a desired position and fixing it there. The trigger lever 214 can be thereby maintained in the state of being pushed even after the user releases the trigger lever 214.

As illustrated in FIG. 12, the operation panel 218 is located rightward of the control lever 216. The operation panel 218 comprises a main power button 294 (see FIG. 20) for receiving an operation of turning the main power of the blower 202 on/off and an operation of switching operation mode of the blower 202, a main power indication lamp 336a (see FIG. 20) for indicating whether the main power of the blower 202 is on or off, and a mode indication lamp 336b (see FIG. 20) for indicating an operation mode of the blower 202. The operation mode of the blower 202 is switchable between an operation mode suitable for the blow operation and an operation mode suitable for the suction mode. The maximum rotational speed of the electric motor 226 (i.e., the rotational speed of the electric motor 226 when the trigger switch 292 is pushed to the maximum displacement) in the suction operation mode is less than the maximum rotational speed of the electric motor 226 in the blow operation mode.

A lighting part 332 is located on the upper surface of the housing 210 and forward of the front grip portion 234. The lighting part 332 illuminates a region in front of the blower 202 when the main power of the blower 202 is on. An LED 334 (see FIG. 20) electrically connected to the control unit 228 is located within the lighting part 332. The control unit 228 supplies electric power from the battery pack 242 to the LED 334.

The suction operation is performed by the blower 202 when the electric motor 226 is driven and the fan 230 is rotated while the switching lever 220 is at the collection position as illustrated in FIG. 14. The first fan 284 of the fan 230, during its rotation, draws in air in the suction passage 260 and ejects the air into the first discharge passage 266. Thereby, air outside the blower 202 flows into the suction nozzle 208 through the suction opening 244 (see FIG. 12), flows through the suction nozzle 208, the intake pipe 204, the suction passage 260, the volute passage 258, the first discharge passage 266, and the duct member 252, and then flows into the collection bag 222. The blower 202 can collect debris into the collection bag 222 using this air flow. For example, when the user moves the blower 202 such that the suction nozzle 208 is moved along the ground, debris on the ground is suctioned into the suction opening 244 with surrounding air. After suctioned into the suction opening 244, the debris passes through the suction nozzle 208 and the intake pipe 204 into the suction passage 260 and is broken into pieces by the blades 288. The pieces of debris pass through the volute passage 258 into the first discharge passage 266 and then is collected into the collection bag 222. The second fan 286 of the fan 230, during its rotation, draws in air in the motor housing 270 and ejects the air into the first discharge passage 266. After discharged into the first discharge passage 266, the air flows through the duct member 252 into the collection bag 222. Thereby, air outside the blower 202 flows into the housing 210 through the vent opening 278 (see FIG. 12), flows through the motor housing 270, the volute passage 258, and the first discharge passage 266, and then flows into the collection bag 222. The blower 202 can cool the electric motor 226 and the control unit 228 housed in the housing 210 using this air flow. When the suction nozzle 208 is detached from the intake pipe 204, the blower 202 suctions debris through the first distal end opening 238.

The blow operation is performed by the blower 202 when the electric motor 226 is driven and the fan 230 is rotated while the switching lever 220 is at the non-collection position as illustrated in FIG. 15. The first fan 284 of the fan 230, during its rotation, draws in air from the suction passage 260 and ejects the air into the second discharge passage 268. Thereby, air outside the blower 202 flows into the suction nozzle 208 through the suction opening 244 (see FIG. 12), flows through the suction nozzle 208, the intake pipe 204, the suction passage 260, the volute passage 258, the second discharge passage 268, and the discharge pipe 206, and then flows out from the blower 202 through the second distal end opening 240 (see FIG. 12). Thus, the air is blown out forward from the second distal end opening 240. The user can, for example, blow off debris on the ground using the air blown out from the second distal end opening 240. The second fan 286 of the fan 230 generates an air flow for cooling the electric motor 226 and the control unit 228 in the same way as it does in the suction operation.

As illustrated in FIG. 18, the blower 202 further comprises a maintenance hole 296 penetrating the side wall of the housing 210 in the right-left direction and a maintenance cover 298 for opening and closing the maintenance hole 296.

The maintenance hole 296 is in communication with the internal spaces of the air passages 256. The maintenance hole 296 comprises a first hole portion 300 having a substantially rectangular shape and a second hole portion 302 having a substantially trapezoidal shape. The first hole portion 300 and the second hole portion 302 are continuous on the outer surface of the housing 210. The first hole portion 300 faces the internal space of the volute passage 258 in the right-left direction. As viewed from the right side, the first hole portion 300 overlaps substantially the entire fan 230. The first hole portion 300 also overlaps the projection 290. The transverse direction of the first hole portion 300 is along the axial direction of the fan 230. The longitudinal width of the first hole portion 300 is greater than the diameter of the fan 230. The second hole portion 302 faces the internal space of the suction passage 260 in the right-left direction. The second hole portion 302 projects forward and upward from the front long side of the first hole portion 300. The width of the second hole portion 302 in the direction along the front long side of the first hole portion 300 decreases as the distance from the first hole portion 300 increases. As viewed from the right side, the second hole portion 302 overlaps distal ends of the blades 288. The user can perform maintenance on the fan 230 and the blades 288 through the maintenance hole 296.

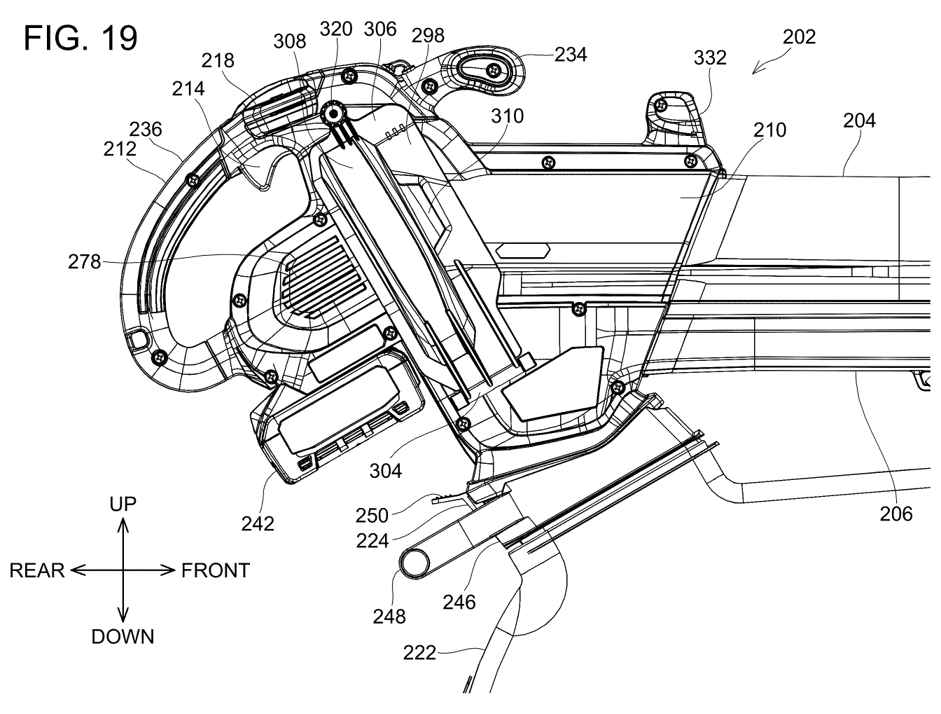

The maintenance cover 298 comprises a tubular portion 304, a plate portion 306, a first cover portion 308, and a second cover portion 310. A pivot shaft 330 (see FIG. 17) is inserted in the tubular portion 304, and the pivot shaft 330 is rotatably attached to the housing 210. The pivot shaft 330 extends along the axial direction of the fan 230. The maintenance cover 298 is pivotable about the pivot shaft 330 between an open position where the maintenance cover 298 opens the maintenance hole 296 (i.e., the position illustrated in FIG. 18) and a close position where the maintenance cover 298 closes the maintenance hole 296 (i.e., the position illustrated in FIG. 19). The plate portion 306 has a shape along the outer surface of the housing 210. The first cover portion 308 faces the first hole portion 300 when the maintenance cover 298 is at the close position. The inner surface of the first cover portion 308 is shaped to project toward the outside of the housing 210 as viewed from the plate portion 306 and forms a part of the volute passage 258. The inner surface of the second cover portion 310 is shaped to project toward the inside of the housing 210 as viewed from the plate portion 306 and forms a part of the suction passage 260. The tubular portion 304, the plate portion 306, the first cover portion 308, and the second cover portion 310 are integrally formed seamlessly.

The housing 210 comprises a sealing groove 312. The sealing groove 312 is formed in the outer surface of the housing 210 and extends along the entire periphery of the maintenance hole 296. A sealing member 314 (e.g., a sponge) is attached to the sealing groove 312. The maintenance cover 298 comprises a push rib 316 for pushing the sealing member 314. The push rib 316 projects from the inner surface of the plate portion 306 toward the inside of the housing 210. When the maintenance cover 298 is at the close position, the push rib 316 pushes the sealing member 314 along the entire periphery of the maintenance hole 296. Thereby, sealing is provided between the housing 210 and the maintenance cover 298.

The housing 210 further comprises a screw hole 318. The screw hole 318 is formed in the outer surface of the housing 210 and located above the sealing groove 312. The maintenance cover 298 comprises a screw 320 engageable in the screw hole 318. The screw 320 is rotatably supported on an end portion of the plate portion 306. The user can fix the maintenance cover 298 at the close position by moving the maintenance cover 298 to the close position and then screwing the screw 320 into the screw hole 318.

The housing 210 further comprises a detection hole 322. The detection hole 322 is formed in the outer surface of the housing 210 and located forward of the screw hole 318. Within the housing 210, a detection member 324 and a detection switch 328 (see FIG. 20) are located at a position corresponding to the detection hole 322. The detection member 324 is biased rightward by a compression spring (not illustrated). The maintenance cover 298 comprises a detection projection 326 insertable into the detection hole 322. The detection projection 326 projects from the inner surface of the plate portion 306 toward the inside of the housing 210. When the maintenance cover 298 is at the close position, the detection projection 326 is inserted in the detection hole 322 and thus pushes the detection member 324. The detection member 324 is thus moved leftward against the biasing force of the compression spring. When the maintenance cover 298 is moved from the close position toward the open position, the detection projection 326 comes out from the detection hole 322 and thus does not push the detection member 324 any longer. The detection member 324 is thus moved rightward by the biasing force of the compression spring. The detection switch 328 is electrically connected to the control unit 228 and outputs an on/off signal that indicates ON when the detection member 324 is pushed by the detection projection 326, while it indicates OFF when the detection member 324 is not pushed by the detection projection 326. The detection switch 328 may be a contact detection sensor such as a mechanical microswitch or a non-contact detection sensor such as a magnetic sensor.

As illustrated in FIG. 20, the control unit 228 comprises a power control unit 338, a main power FET 340, a regulator 342, an MCU 344, a gate driver 346, and an inverter circuit 348. The power control unit 338 controls the main power FET 340 and the regulator 342. The main power FET 340 is arranged on a power supply path through which electric power from the battery pack 242 is supplied to the inverter circuit 348. The power control unit 338 keeps the main power FET 340 conductive while the main power of the blower 202 is on and keeps the main power FET 340 non-conductive while the main power of the blower 202 is off. The regulator 342 decreases the voltage from the battery pack 242 and supplies it to the MCU 344, etc. The MCU 344 controls the inverter circuit 348 via the gate driver 346. The inverter circuit 348 comprises six motor drive FETs 348a, 348b, 348c, 348d, 348e, 348f. The coils 276a of the electric motor 226 comprise a U-phase terminal 276b, a V-phase terminal 276c, and a W-phase terminal 276d. The motor drive FET 348a connects the power supply potential to the U-phase terminal 276b of the electric motor 226, the motor drive FET 348b connects the power supply potential to the V-phase terminal 276c of the electric motor 226, the motor drive FET 348c connects the power supply potential to the W-phase terminal 276d of the electric motor 226, the motor drive FET 348d connects the ground potential to the U-phase terminal 276b of the electric motor 226, the motor drive FET 348e connects the ground potential to the V-phase terminal 276c of the electric motor 226, and the motor drive FET 348f connects the ground potential to the W-phase terminal 276d of the electric motor 226. The power supply potential is connected to the positive potential of the battery pack 242 via the main power FET 340. The ground potential is connected to the negative potential of the battery pack 242. Detection signals from the Hall sensors 350 of the electric motor 226 are input to the MCU 344. The MCU 344 controls electric power supplied to the electric motor 226 via the U-phase terminal 276b, the V-phase terminal 276c, and the W-phase terminal 276d by switching each of the motor drive FETs 348a, 348b, 348c, 348d, 348e, 348f between being conductive and non-conductive based on the detection signals from the Hall sensors 350, thereby controlling the electric motor 226. The control unit 228 can suddenly stop the electric motor 226 by making all of the motor drive FETs 348a, 348b, 348c non-conductive and making all of the motor drive FETs 348d, 348e, 348f conductive while the electric motor 226 is rotating. Further, the control unit 228 can stop the electric motor 226 by making all of the motor drive FETs 348a, 348b, 348c non-conductive, making two of the motor drive FETs 348d, 348e, 348f conductive and making the remaining one of the motor drive FETs 348d, 348e, 348f non-conductive while the electric motor 226 is rotating. In this case, the control unit 228 switches two of the motor drive FETs 348d, 348e, 348f to be conductive and the remaining one of the motor drive FETs 348d, 348e, 348f to be non-conductive based on detection signals from the Hall sensors 350 so that a brake current of appropriate magnitude flows through the electric motor 226. Herein, this stopping manner of the electric motor 226 is also referred to as a stop by two-phase short-circuit brake. A braking force acting on the electric motor 226 by the two-phase short-circuit brake is less than a braking force acting on the electric motor 226 by the three-phase short-circuit brake but is greater than a braking force acting on the electric motor 226 when the electric motor 226 freewheels.

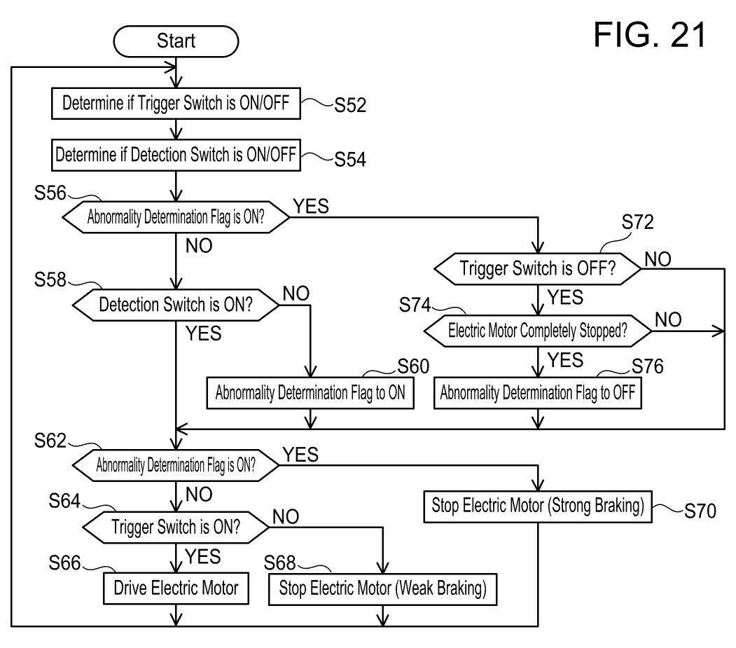

(Exemplary Process Performed by Control Unit 228) Hereinafter, a process performed by the control unit 228 is described with reference to FIG. 21. The control unit 228 starts the process illustrated in FIG. 21 in response to the main power of the blower 202 being turned on and electric power being supplied to the control unit 228. At the start of the process illustrated in FIG. 21, the trigger switch 292 and the detection switch 328 are both in OFF state. Further, the abnormality determination flag indicates OFF.

In S52, the control unit 228 determines whether the trigger switch 292 is in an ON state or OFF state. The control unit 228 determines that the trigger switch 292 has shifted from the ON state to the OFF state in case the on/off signal from the trigger switch 292 changes from indicating the ON state to indicating the OFF state while the trigger switch 292 is determined to be in the ON state and keeps indicating the OFF state for a predetermined period (e.g., 20 ms). Further, the control unit 228 determines that the trigger switch 292 has shifted from the OFF state to the ON state in case the on/off signal from the trigger switch 292 changes from indicating the OFF state to indicating the ON state while the trigger switch 292 is determined to be in the OFF state and keeps indicating the ON state for a predetermined period (e.g., 20 ms).

In S54, the control unit 228 determines whether the detection switch 328 is in an ON state or OFF state. The control unit 228 determines that the detection switch 328 has shifted from the ON state to the OFF state in case the on/off signal from the detection switch 328 changes from indicating the ON state to indicating the OFF state while the detection switch 328 is determined to be in the ON state and keeps indicating the OFF state for a predetermined period (e.g., 0.1 ms). Further, the control unit 228 determines that the detection switch 328 has shifted from the OFF state to the ON state in case the on/off signal from the detection switch 328 changes from indicating the OFF state to indicating the ON state while the detection switch 328 is determined to be in the OFF state and keeps indicating the ON state for a predetermined period (e.g., 0.1 ms).

In S56, the control unit 228 determines whether the abnormality determination flag indicates ON or not. In case the abnormality determination flag indicates OFF (NO in S56), the flow proceeds to S58.

In S58, the control unit 228 determines whether the detection switch 328 is in the ON state or not. In case the detection switch 328 is in the ON state (YES in S58), the flow proceeds to S62.

In case the detection switch 328 is in the OFF state in S58 (NO in S58), the flow proceeds to S60. In S60, the control unit 228 changes the abnormality determination flag to ON. After S60, the flow proceeds to S62.

In S62, the control unit 228 determines whether the abnormality determination flag indicates ON or not. In case the abnormality determination flag indicates OFF (NO in S62), the flow proceeds to S64.

In S64, the control unit 228 determines whether the trigger switch 292 is in the ON state or not. In case the trigger switch 292 is in the ON state (YES in S64), the flow proceeds to S66. In S66, the control unit 228 drives the electric motor 226. At this time, the control unit 228 adjusts the rotational speed of the electric motor 226 according to the current operation mode and the displacement of the trigger switch 292. After S66, the flow returns to S52.

In case the trigger switch 292 is in the OFF state in S64 (NO in S64), the flow proceeds to S68. In S68, the control unit 228 stops the electric motor 226 by weak braking. The control unit 228 stopping the electric motor 226 by weak braking means that the control unit 228 stops the electric motor 226 by the two-phase short-circuit brake. After S68, the flow returns to S52.

In case the abnormality determination flag indicates ON in S62 (YES in S62), the flow proceeds to S70. In S70, the control unit 228 stops the electric motor 226 by strong braking. The control unit 228 stopping the electric motor 226 by strong braking means that the control unit 228 first brakes the electric motor 226 by the two-phase short-circuit brake, and then, in response to the rotational speed of the electric motor 226 decreasing to a predetermined speed, brakes the electric motor 226 by the three-phase short-circuit brake. After S70, the flow returns to S52.

In case the abnormality determination flag indicates ON in S56 (YES in S56), the flow proceeds to S72. In S72, the control unit 228 determines whether the trigger switch 292 is in the OFF state or not. In case the trigger switch 292 is in the ON state (NO in S72), the flow proceeds to S62. In case the trigger switch 292 is in the OFF state (YES in S72), the flow proceeds to S74. In S74, the control unit 228 determines whether the electric motor 226 is completely stopped or not. In case the electric motor 226 is not completely stopped (NO in S74), the flow proceeds to S62. In case the electric motor 226 is completely stopped (YES in S74), the flow proceeds to S76. In S76, the control unit 228 changes the abnormality determination flag to OFF. After S76, the flow proceeds to S62.

In the process illustrated in FIG. 21, in case the trigger switch 292 is in the OFF state and the detection switch 328 is in the ON state after the main power of the blower 202 was turned on, the abnormality determination flag indicates OFF in S62 (see S56, S58). Therefore, when the trigger switch 292 shifts from the OFF state to the ON state while the detection switch 328 is in the ON state, the control unit 228 drives the electric motor 226 (see S62, S64, S66).

Further, when the trigger switch 292 shifts from the ON state to the OFF state while the detection switch 328 is in the ON state, the control unit 228 stops the electric motor 226 by weak braking (see S62, S64, S68). Thereby, the electric motor 226 is gradually stopped.

When the detection switch 328 shifts from the ON state to the OFF state while the trigger switch 292 is in the ON state after the control unit 228 started driving the electric motor 226 in S66, the abnormal determination flag is changed from OFF to ON (see S56, S58, S60). In this case, the control unit 228 stops the electric motor 226 by strong braking (see S62, S70). Thereby, the electric motor 226 is promptly stopped. Thereafter, regardless of whether the detection switch 328 is in the ON state or the OFF state, the abnormal determination flag is maintained ON (see S56, S72) and the electric motor 226 is prohibited from being driven (see S62, S70) until the trigger switch 292 shifts from the ON state to the OFF state. When the trigger switch 292 shifts from the ON state to the OFF state, the abnormality determination flag changes from ON to OFF (see S56, S72, S74, S76) and the prohibition on driving the electric motor 226 is released (see S62, S64, S66).

During the control unit 228 stopping the electric motor 226 by weak braking in S68, when the detection switch 328 shifts from the ON state to the OFF state before the electric motor 226 is completely stopped, the abnormal determination flag changes from OFF to ON (see S56, S58, S60). In this case, the electric motor 226 is promptly stopped since the control unit 228 stops the electric motor 226 by strong braking (see S62, S70).

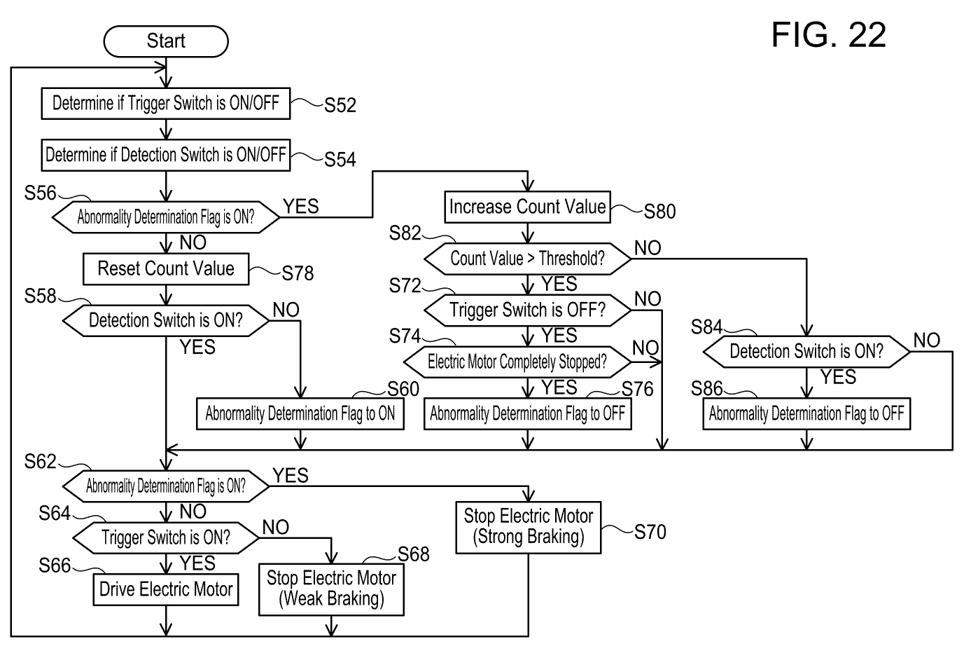

(Another Exemplary Process Performed by Control Unit 228) The control unit 228 may perform the process illustrated in FIG. 22 instead of the process illustrated in FIG. 21. The process illustrated in FIG. 22 includes additional steps of S78, S80, S82, S84, and S86 compared to the process illustrated in FIG. 21, but except for the additional steps, it is substantially the same as the process illustrated in FIG. 21. Hereinafter, differences of the process illustrated in FIG. 22 from the process illustrated in FIG. 21 are described.

In the process illustrated in FIG. 22, in case the abnormality determination flag indicates OFF in S56 (NO in S56), the flow proceeds to S78. In S78, the control unit 228 resets a count value. After S78, the flow proceeds to S58.

In case the abnormality determination flag indicates ON in S56 (YES in S56), the flow proceeds to S80. In S80, the control unit 228 increases the count value. After S80, the flow proceeds to S82.

In S82, the control unit 228 determines whether the count value exceeds a threshold or not. In case the count value exceeds the threshold (YES in S82) (i.e., in case a predetermined period has elapsed since the abnormality determination flag changed from OFF to ON in S60 after the count value had been reset in S78), the flow proceeds to S72. In case the count value is equal to or less than the threshold (NO in S82) (i.e., in case the predetermined period has not elapsed yet since the abnormality determination flag changed from OFF to ON in S60 after the count value had been reset in S78), the flow proceeds to S84.

In S84, the control unit 228 determines whether the detection switch 328 is in the ON state or not. In case the detection switch 328 is in the ON state (YES in S84), the flow proceeds to S86.

In S86, the control unit 228 changes the abnormality determination flag to OFF. After S86, the flow proceeds to S62.

In case the detection switch 328 is in the OFF state in S84 (NO in S84), the flow proceeds to S62.

In the process illustrated in FIG. 22, in case the detection switch 328 shifts from the ON state to the OFF state while the trigger switch 292 is in the ON state after the control unit 228 started driving the electric motor 226 in S66, the abnormality determination flag is changed from OFF to ON (see S56, S78, S58, S60). In this case, the control unit 228 stops the electric motor 226 by strong braking (see S62, S70). Thereby, the electric motor 226 is promptly stopped. In case the detection switch 328 shifts to ON state before the predetermined period elapses from when the electric motor 226 was stopped by strong braking in S70, the abnormality determination flag is changed from ON to OFF (see S56, S80, S70, S84, S86). In this case, driving the electric motor 226 is not prohibited, and thus the electric motor 226 is driven again when the trigger switch 292 shifts to the ON state (see S62, S64, S66). Once the predetermined period has elapsed from when the electric motor 226 was stopped by strong braking in S70, the abnormality determination flag is thereafter maintained ON (see S56, S82, S72) and the electric motor 226 is prohibited from being driven (see S62, S70) until the trigger switch 292 shifts from the ON state to the OFF state, regardless of whether the detection switch 328 is in the ON state or OFF state. When the trigger switch 292 shifts from the ON state to the OFF state, the abnormality determination flag is changed from ON to OFF (see S56, S82, S72, S74, S76), thereby the prohibition on driving the electric motor 226 is released (see S62, S64, S66).

(Modifications) In the first and second embodiments, the blower 2, 202 may comprise an internal combustion engine (not illustrated) instead of the electric motor 8, 226, as a prime mover. Alternatively, the blower 2, 202 may comprise a brushed electric motor 8, 226 instead of the brushless electric motor 8, 226, as a prime mover or may comprise the electric motor 8, 226 of another type as a prime mover. The blower 2, 202 may comprise a so-called outer-rotor electric motor 8, 226 in which the rotor 8c, 274 is located radially outward of the stator 8e, 276.

In the first and second embodiments, the blower 2, 202 may comprise an undetachable built-in battery (not illustrated) housed in the housing 4, 210, instead of the battery pack 12, 242 detachably attached to the housing 4, 210. Alternatively, the blower 2, 202 may comprise a power cable (not illustrated) through which electric power is supplied from an external power supply (not illustrated), instead of the battery pack 12, 242.

In the first embodiment, the blower 2 may be configured such that it can be used only with the intake port cover 18 for the intake port 14 closed and the blow nozzle 28 attached to the exhaust port 16, as illustrated in FIG. 3. In this case, the blower 2 can perform only the blow operation of blowing air out from the distal end portion 28a of the blow nozzle 28 to blow off debris such as fallen leaves. Alternatively, the blower 2 may be configured such that it can be used only with the intake port cover 18 for the intake port 14 opened, the suction nozzle 30 attached to the intake port 14, and the dust bag 34 attached to the exhaust port 16 via the bent pipe 32, as illustrated in FIG. 4. In this case, the blower 2 can perform only the suction operation of suctioning air in from the distal end portion 30a of the suction nozzle 30 to suction and collect debris such as fallen leaves into the dust bag 34.

In the first and second embodiments, the blower 2, 202 may not comprise multiple operation modes. In this case, the control unit 10, 228 may perform the blow operation and the suction operation in the same operation mode.

In the first and second embodiments, the blower 2, 202 may comprise an axial fan (not illustrated) instead of the first fan 6b, 284 and/or the second fan 6c, 286 which are centrifugal fans.

In the first embodiment, the blower 2 may stop the electric motor 8 in a manner different from the freewheeling and the three-phase short-circuit brake. For example, the blower 2 may comprise a mechanical brake (not illustrated) configured to mechanically brake the rotation of the electric motor 8. In this case, the control unit 10 may stop the electric motor 8 by the mechanical brake in S24 of the process(es) illustrated in FIG. 10 and/or FIG. 11.

In the second embodiment, in S68 of the process(es) illustrated in FIG. 21 and/or FIG. 22 (braking the electric motor 226 by weak braking), the control unit 228 may brake the electric motor 226 by the two-phase short-circuit brake where timings to switch the motor drive FETs 348d, 348e, 348f between being conductive and non-conductive are adjusted to provide a small braking force. Alternatively, the blower 202 may use another electric brake (e.g., an electric brake using a low-resistance braking resistor) or another type of brake (e.g., a mechanical brake having a weak braking force) in the weak braking. In S70 of the process(es) illustrated in FIG. 21 and/or FIG. 22 (braking the electric motor 226 by strong braking), the control unit 228 may brake the electric motor 226 by the two-phase short-circuit brake where timings to switch the motor drive FETs 348d, 348e, 348f between being conductive and non-conductive are adjusted to provide a large braking force. Alternatively, the blower 202 may use another electric brake (e.g., an electric brake using a large-resistance braking resistor) or another type of brake (e.g., a mechanical brake having a strong braking force) in the strong braking.

In the first embodiment, the blower 2 may comprise an intake port attachment member of another type, different from the intake port cover 18 and the suction nozzle 30, as the intake port attachment member detachably attached to the intake port 14.

In the first embodiment, the blower 2 may comprise an exhaust port attachment member of another type, different from the blow nozzle 28 and the bent pipe 32, as the exhaust port attachment member detachably attached to the exhaust port 16.

In the first and second embodiments, the blower 2, 202 may comprise an operation member of another type, different from the trigger lever 20, 214, as the operation member.

(Features of Embodiments) As described above, in one or more embodiments, the blower 2 comprises the fan 6; the electric motor 8 (an example of prime mover) configured to rotate the fan 6; the intake port 14 through which air flows in due to rotation of the fan 6, wherein the intake port 14 allows access to the fan 6 from outside; the intake port cover 18 or the suction nozzle 30 (an example of intake port attachment member) detachably attachable to the intake port 14; the second detection switch 84 (an example of intake port detection sensor) configured to be in the ON state (an example of first state) when the intake port cover 18 or the suction nozzle 30 is attached to the intake port 14 and be in the OFF state (an example of second state) when the intake port cover 18 or the suction nozzle 30 is not attached to the intake port 14; the trigger lever 20 (an example of operation member) configured to receive an operation for rotating the fan 6; the trigger switch 66 (an example of operation detection sensor) configured to detect whether the trigger lever 20 is operated or not; and the control unit 10 configured to control the electric motor 8. The control unit 10 is configured to drive the electric motor 8 in case the second detection switch 84 is in the ON state and the trigger switch 66 is in the ON state; to stop the electric motor 8 in case the second detection switch 84 is in the ON state and the trigger switch 66 is in the OFF state; and to stop the electric motor 8 in case the second detection switch 84 shifts from the ON state to the OFF state while the trigger switch 66 is in the ON state, and thereafter, to prohibit driving the electric motor 8 until the trigger switch 66 shifts from the ON state to the OFF state.

The above configuration stops the electric motor 8 when the intake port cover 18 or the suction nozzle 30 is detached from the intake port 14 while the trigger switch 66 is in the ON state and prohibits driving the electric motor 8 until the trigger switch 66 subsequently shifts from the ON state to the OFF state. Therefore, if the user has forgotten that the trigger switch 66 is still in the ON state after the electric motor 8 was stopped in response to the detachment of the intake port cover 18 or the suction nozzle 30 from the intake port 14 and attaches the intake port cover 18 or the suction nozzle 30 to the intake port 14, electric motor 8 will not be driven. The above configuration thus prevents the electric motor 8 from being driven unexpectedly.

In one or more embodiments, the control unit 10 is configured to stop the electric motor 8 in case the second detection switch 84 shifts from the ON state to the OFF state while the trigger switch 66 is in the ON state; not to prohibit driving electric motor 8 until the predetermined period elapses since the electric motor 8 was stopped; and after the predetermined period has elapsed from when the electric motor 8 was stopped, to prohibit driving the electric motor 8 until the trigger switch 66 shifts from the ON state to the OFF state.

The second detection switch 84 may repeatedly shift between the ON state and the OFF state within a short period of time, for example, due to chattering. If the electric motor 8 is prohibited from being driven even in such a case until the trigger switch 66 shifts from the ON state to the OFF state after the electric motor 8 was stopped in response to the second detection switch 84 having shifted from the ON state to the OFF state, user convenience may be impaired. According to the configuration above, in such a case where the second detection switch 84 repeatedly shifts between the ON state and the OFF state within a short period of time, the electric motor 8 is driven again in response to the second detection switch 84 shifting from the OFF state to the ON state even if the trigger switch 66 does not shift from the ON state to the OFF state after the electric motor 8 was stopped in response to the second detection switch 84 having shifted from the ON state to the OFF state. This configuration can maintain user convenience while preventing the electric motor 8 from being driven unexpectedly.

In one or more embodiments, the control unit 10 is configured, in case the signal from the trigger switch 66 changes from indicating one of the ON state and the OFF state to indicating the other of the ON state and the OFF state and keeps indicating the other of the ON state and the OFF state over a predetermined operation determination period (e.g., 20 ms), to determine that the trigger switch 66 has shifted from the one of the ON state and the OFF state to the other of the ON state and the OFF state; and in case the signal from the second detection switch 84 changes from indicating one of the ON state and the OFF state to indicating the other of the ON state and the OFF state and keeps indicating the other of the ON state and the OFF state over a predetermined detection determination period (e.g., 0.1 ms), to determine that the second detection switch 84 has shifted from the one of the ON state and the OFF state to the other of the ON state and the OFF state. The detection determination period (e.g., 0.1 ms) is shorter than the operation determination period (e.g., 20 ms).

With the configuration above, the control unit 10 can promptly recognize that the second detection switch 84 has shifted from one of the ON state and the OFF state to the other of the ON state and the OFF state.

In one or more embodiments, the control unit 10 is configured to stop the electric motor 8 in a first manner (e.g., by freewheeling) in case the trigger switch 66 shifts from the ON state to the OFF state while the second detection switch 84 is in the ON state; and to stop the electric motor 8 in a second manner (e.g., by the three-phase short-circuit brake) in case the second detection switch 84 shifts from the ON state to the OFF state while the trigger switch 66 is in the ON state. A period required for the electric motor 8 to stop in the second manner (e.g., by the three-phase short-circuit brake) is shorter than a period required for the electric motor 8 to stop in the first manner (e.g., by freewheeling).

With the configuration above, the electric motor 8 is stopped gradually in response to the trigger switch 66 shifting from the ON state to the OFF state, that is, in response to the operation on the trigger lever 20 being released, which improves user operability. Further, with the configuration above, the electric motor 8 is stopped promptly in response to the second detection switch 84 shifting from the ON state to the OFF state, that is, in response to the intake port cover 18 or the suction nozzle 30 being detached from the intake port 14, which ensures user safety.

In one or more embodiments, the electric motor 8 functions as a prime mover. The control unit 10 stopping the electric motor 8 in the first manner comprises the control unit 10 stopping the electric motor 8 by freewheeling. The control unit 10 stopping the electric motor 8 in the second manner comprises the control unit 10 stopping the electric motor 8 by the three‑phase short‑circuit brake.

With the configuration above, the electric motor 8 is stopped gradually in response to the trigger switch 66 shifting from the ON state to the OFF state, that is, in response to the operation on the trigger lever 20 being released, which improves user operability. Further, with the configuration above, the electric motor 8 is stopped promptly in response to the second detection switch 84 shifting from the ON state to the OFF state, that is, in response to the intake port cover 18 or the suction nozzle 30 being detached from the intake port 14, which ensures user safety.

In one or more embodiments, the blower 2 further comprises the exhaust port 16 through which air flows out due to rotation of the fan 6; the blow nozzle 28 or bent pipe 32 (an example of exhaust port attachment member) detachably attachable to the exhaust port 16; and the first detection switch 74 (an example of exhaust port detection sensor) configured to be in the ON state (an example of third state) when the blow nozzle 28 or the bent pipe 32 is attached to the exhaust port 16 and be in the OFF state (an example of fourth state) when the blow nozzle 28 or the bent pipe 32 is not attached to the exhaust port 16. The control unit 10 is configured to drive the electric motor 8 in case the second detection switch 84 is in the ON state, the first detection switch 74 is in the ON state, and the trigger switch 66 is in the ON state; to stop the electric motor 8 in case the second detection switch 84 is in the ON state, the first detection switch 74 is in the ON state, and the trigger switch 66 is in the OFF state; and to stop the electric motor 8 in case the second detection switch 84 shifts from the ON state to the OFF state while the trigger switch 66 is in the ON state or in case the first detection switch 74 shifts from the ON state to the OFF state while the trigger switch 66 is in the ON state, and thereafter, to prohibit driving the electric motor 8 until the trigger switch 66 shifts from the ON state to the OFF state.

The above configuration stops the electric motor 8 when the intake port cover 18 or the suction nozzle 30 or the blow nozzle 28 or the bent pipe 32 is detached from the intake port 14 or the exhaust port 16 while the trigger switch 66 is in the ON state and prohibits driving the electric motor 8 until the trigger switch 66 subsequently shifts from the ON state to the OFF state. Therefore, if the user has forgotten that the trigger switch 66 is still in the ON state after the electric motor 8 was stopped in response to the detachment of the intake port cover 18 or the suction nozzle 30 or the blow nozzle 28 or the bent pipe 32 from the intake port 14 or the exhaust port 16 and attaches the intake port cover 18 or the suction nozzle 30 or the blow nozzle 28 or the bent pipe 32 to the intake port 14 or the exhaust port 16, the electric motor 8 will not be driven. The above configuration thus prevents the electric motor 8 from being driven unexpectedly.

In one or more embodiments, the blower 2, 202 comprises the fan 6, 230; the electric motor 8, 226 (an example of prime mover) configured to rotate the fan 6, 230; the detachable intake port cover 18, suction nozzle 30, blow nozzle 28, bent pipe 32 or the maintenance cover 298 (examples of attachment member); the second detection switch 84, the first detection switch 74, or the detection switch 328 (examples of attachment detection sensor) configured to be in the ON state (an example of first state) when the intake port cover 18, the suction nozzle 30, the blow nozzle 28, the bent pipe 32, or the maintenance cover 298 is attached and be in the OFF state (an example of second state) when the intake port cover 18, the suction nozzle 30, the blow nozzle 28, the bent pipe 32, or the maintenance cover 298 is not attached; the trigger lever 20, 214 (an example of operation member) configured to receive an operation for rotating the fan 6, 230; the trigger switch 66, 292 (an example of operation detection sensor) configured to detect whether the trigger lever 20, 214 is operated or not; and the control unit 10, 228 configured to control the electric motor 8, 226. The control unit 10, 228 is configured to drive the electric motor 8, 226 in case the second detection switch 84, the first detection switch 74, or the detection switch 328 is in the ON state and the trigger switch 66, 292 is in the ON state; to stop the electric motor 8, 226 in case the second detection switch 84, the first detection switch 74, or the detection switch 328 is in the ON state and the trigger switch 66, 292 is in the OFF state; and to stop the electric motor 8, 226 in case the second detection switch 84, the first detection switch 74, or the detection switch 328 shifts from the ON state to the OFF state while the trigger switch 66, 292 is in the ON state, and thereafter, to prohibit driving the electric motor 8, 226 until the trigger switch 66, 292 shifts from the ON state to the OFF state.

The above configuration stops the electric motor 8, 226 when the intake port cover 18, the suction nozzle 30, the blow nozzle 28, the bent pipe 32, or the maintenance cover 298 is detached while the trigger switch 66, 292 is in the ON state and prohibits driving the electric motor 8, 226 until the trigger switch 66, 292 subsequently shifts from the ON state to the OFF state. Therefore, if the user has forgotten that the trigger switch 66, 292 is still in the ON state after the electric motor 8, 226 was stopped in response to the detachment of the intake port cover 18, the suction nozzle 30, the blow nozzle 28, the bent pipe 32, or the maintenance cover 298 and attaches the intake port cover 18, the suction nozzle 30, the blow nozzle 28, the bent pipe 32, or the maintenance cover 298, the electric motor 8, 226 will not be driven. The above configuration thus prevents the electric motor 8, 226 from being driven unexpectedly.

In one or more embodiments, the intake port cover 18, the suction nozzle 30, the blow nozzle 28, the bent pipe 32, or the maintenance cover 298 is detachably attachable to a flow passage through which air flows due to rotation of the fan 6, 230.

With the configuration above, the electric motor 8, 226 is prevented from being driven unexpectedly in the blower 2, 202 comprising the intake port cover 18, the suction nozzle 30, the blow nozzle 28, the bent pipe 32, or the maintenance cover 298 detachably attachable to a flow passage through which air flows due to rotation of the fan 6, 230.

In one or more embodiments, the control unit 10, 228 is configured to stop the electric motor 8, 226 in case the second detection switch 84, the first detection switch 74, or the detection switch 328 shifts from the ON state to the OFF state while the trigger switch 66, 292 is in the ON state; not to prohibit driving the electric motor 8, 226 until the predetermined period elapses since the electric motor 8, 226 was stopped; and after the predetermined period has elapsed from when the electric motor 8, 226 was stopped, to prohibit driving the electric motor 8, 226 until the trigger switch 66, 292 shifts from the ON state to the OFF state.

The second detection switch 84, the first detection switch 74, or the detection switch 328 may repeatedly shift between the ON state and the OFF state within a short period of time, for example, due to chattering. If the electric motor 8, 226 is prohibited from being driven even in such a case until the trigger switch 66, 292 shifts from the ON state to the OFF state after the electric motor 8, 226 was stopped in response to the second detection switch 84, the first detection switch 74, or the detection switch 328 having shifted from the ON state to the OFF state, user convenience may be impaired. According to the configuration above, in such a case where the second detection switch 84, the first detection switch 74, or the detection switch 328 repeatedly shifts between the ON state and the OFF state within a short period of time, the electric motor 8, 226 is driven again in response to the second detection switch 84, the first detection switch 74, or the detection switch 328 shifting from the OFF state to the ON state even if the trigger switch 66, 292 does not shift from the ON state to the OFF state after the electric motor 8, 226 was stopped in response to the second detection switch 84, the first detection switch 74, or the detection switch 328 having shifted from the ON state to the OFF state. This configuration maintains user convenience while preventing the electric motor 8, 226 from being driven unexpectedly.

In one or more embodiments, the control unit 10, 228 is configured, in case the signal from the trigger switch 66, 292 changes from indicating one of the ON state and the OFF state to indicating the other of the ON state and the OFF state and keeps indicating the other of the ON state and the OFF state over a predetermined operation determination period (e.g., 20ms), to determine that the trigger switch 66, 292 has shifted from the one of the ON state and the OFF state to the other of the ON state and the OFF state; and in case the signal from the second detection switch 84, the first detection switch 74, or the detection switch 328 changes from indicating one of the ON state and the OFF state to indicating the other of the ON state and the OFF state and keeps indicating the other of the ON state and the OFF state over a predetermined detection determination period (e.g., 0.1 ms), to determine that the second detection switch 84, the first detection switch 74, or the detection switch 328 has shifted from the one of the ON state and the OFF state to the other of the ON state and the OFF state. The detection determination period (e.g., 0.1 ms) is shorter than the operation determination period (e.g., 20 ms).

With the configuration above, the control unit 10, 228 can promptly recognize that the second detection switch 84, the first detection switch 74, or the detection switch 328 has shifted from one of the ON state and the OFF state to the other of the ON state and the OFF state.

In one or more embodiments, the control unit 10, 228 is configured to stop the electric motor 8, 226 in a first manner (e.g., by freewheeling or the weak braking) in case the trigger switch 66, 292 shifts from the ON state to the OFF state while the second detection switch 84, the first detection switch 74, or the detection switch 328 is in the ON state; and to stop the electric motor 8, 226 in a second manner (e.g., by the three-phase short-circuit brake or the strong brake) in case the second detection switch 84, the first detection switch 74, or the detection switch 328 shifts from the ON state to the OFF state while the trigger switch 66,292 is in the ON state. A period required for the electric motor 8, 226 to stop in the second manner (e.g., by the three-phase short-circuit brake or the strong braking) is shorter than a period required for the electric motor 8, 226 to stop in the first manner (e.g., by freewheeling or the weak braking).

With the configuration above, the electric motor 8, 226 is stopped gradually in response to the trigger switch 66, 292 shifting from the ON state to the OFF state, that is, in response to the operation on the trigger lever 20, 214 being released, which improves user operability. Further, with the configuration above, the electric motor 8, 226 is stopped promptly in response to the second detection switch 84, the first detection switch 74, or the detection switch 328 shifting from the ON state to the OFF state, that is, in response to the intake port cover 18, the suction nozzle 30, the blow nozzle 28, the bent pipe 32, or the maintenance cover 298 being detached, which ensures user safety.

In one or more embodiments, the electric motor 226 functions as a prime mover. The control unit 228 stopping the electric motor 226 in the first manner comprise the control unit 228 stopping the electric motor 226 by the weak braking. The control unit 228 stopping the electric motor 226 in the second manner comprises the control unit 228 stopping the electric motor 226 by the strong braking. The braking force of the strong braking is greater than the braking force of the weak brake. The braking force of the weak braking may be greater than the braking force acting when the electric motor 226 is stopped by freewheeling.

With the configuration above, the electric motor 226 is stopped gradually in response to the trigger switch 292 shifting from the ON state to the OFF state, that is, in response to the operation on the trigger lever 214 being released, which improves user operability. Further, with the configuration above, the electric motor 226 is stopped promptly in response to the detection switch 328 shifting from the ON state to the OFF state, that is, in response to the maintenance cover 298 being detached, which ensures user safety.

What is claimed is:

1. A blower comprising:
a fan;
a prime mover configured to rotate the fan;
an intake port through which air flows in due to rotation of the fan, wherein the intake port allows access to the fan from outside;
an intake port attachment member detachably attachable to the intake port;
an intake port detection sensor configured to be in a first state when the intake port attachment member is attached to the intake port and be in a second state when the intake port attachment member is not attached to the intake port;
an operation member configured to receive an operation for rotating the fan;
an operation detection sensor configured to detect whether the operation is performed on the operation member or not; and
a control unit configured to control the prime mover;
wherein the control unit is configured:
to drive the prime mover in case the intake port detection sensor is in the first state and the operation detection sensor is in an ON state;
to stop the prime mover in case the intake port detection sensor is in the first state and the operation detection sensor is in an OFF state; and
to stop the prime mover in case the intake port detection sensor shifts from the first state to the second state while the operation detection sensor is in the ON state, and thereafter, to prohibit driving the prime mover until the operation detection sensor shifts from the ON state to the OFF state.

2. The blower according to claim 1, wherein the control unit is configured:
to stop the prime mover in case the intake port detection sensor shifts from the first state to the second state while the operation detection sensor is in the ON state;
not to prohibit driving the prime mover until a predetermined period elapses since the prime mover was stopped; and
after the predetermined period has elapsed from when the prime mover was stopped, to prohibit driving the prime mover until the operation detection sensor shifts from the ON state to the OFF state.

3. The blower according to claim 1, wherein the control unit is configured:
in case a signal from the operation detection sensor changes from indicating one of the ON state and the OFF state to indicating another of the ON state and the OFF state and keeps indicating the other of the ON state and the OFF state over a predetermined operation determination period, to determine that the operation detection sensor has shifted from the one of the ON state and the OFF state to the other of the ON state and the OFF state; and
in case a signal from the intake port detection sensor changes from indicating one of the first state and the second state to indicating another of the first state and the second state and keeps indicating the other of the first state and the second state over a predetermined detection determination period, to determine that the intake port detection sensor has shifted from the one of the first state and the second state to the other of the first state and the second state, and
the detection determination period is shorter than the operation determination period.

4. The blower according to claim 1, wherein the control unit is configured:
to stop the prime mover in a first manner in case the operation detection sensor shifts from the ON state to the OFF state while the intake port detection sensor is in the first state; and
to stop the prime mover in a second manner in case the intake port detection sensor shifts from the first state to the second state while the operation detection sensor is in the ON state, and
a period required for the prime mover to stop in the second manner is shorter than a period required for the prime mover to stop in the first manner.

5. The blower according to claim 4, wherein
the prime mover comprises an electric motor,
the control unit stopping the electric motor in the first manner comprises the control unit stopping the electric motor by freewheeling, and
the control unit stopping the electric motor in the second manner comprises the control unit stopping the electric motor by a three‑phase short‑circuit brake.

6. The blower according to claim 1, further comprising:
an exhaust port through which air flows out due to rotation of the fan;
an exhaust port attachment member detachably attachable to the exhaust port; and
an exhaust port detection sensor configured to be in a third state when the exhaust port attachment member is attached to the exhaust port and be in a fourth state when the exhaust port attachment member is not attached to the exhaust port,
wherein the control unit is configured:
to drive the prime mover in case the intake port detection sensor is in the first state, the exhaust port detection sensor is in the third state, and the operation detection sensor is in the ON state;
to stop the prime mover in case the intake port detection sensor is in the first state, the exhaust port detection sensor is in the third state, and the operation detection sensor is in the OFF state; and
to stop the prime mover in case the intake port detection sensor shifts from the first state to the second state while the operation detection sensor is in the ON state or in case the exhaust port detection sensor shifts from the third state to the fourth state while the operation detection sensor is in the ON state, and thereafter, to prohibit driving the prime mover until the operation detection sensor shifts from the ON state to the OFF state.

7. A blower comprising:
a fan;
a prime mover configured to rotate the fan;
a detachable attachment member;
an attachment detection sensor configured to be in a first state when the attachment member is attached and be in a second state when the attachment member is not attached;
an operation member configured to receive an operation for rotating the fan;
an operation detection sensor configured to detect whether the operation is performed on the operation member or not; and
a control unit configured to control the prime mover;
wherein the control unit is configured:
to drive the prime mover in case the attachment detection sensor is in the first state and the operation detection sensor is in an ON state;
to stop the prime mover in case the attachment detection sensor is in the first state and the operation detection sensor is in an OFF state; and
to stop the prime mover in case the attachment detection sensor shifts from the first state to the second state while the operation detection sensor is in the ON state, and thereafter, to prohibit driving the prime mover until the operation detection sensor shifts from the ON state to the OFF state.

8. The blower according to claim 7, wherein the attachment member is detachably attachable to a flow passage through which air flows due to rotation of the fan.

9. The blower according to claim 7, wherein the control unit is configured:
to stop the prime mover in case the attachment detection sensor shifts from the first state to the second state while the operation detection sensor is in the ON state;
not to prohibit driving the prime mover until a predetermined period elapses since the prime mover was stopped; and
after the predetermined period has elapsed from when the prime mover was stopped, to prohibit driving the prime mover until the operation detection sensor shifts from the ON state to the OFF state.

10. The blower according to claim 7, wherein the control unit is configured:
in case a signal from the operation detection sensor changes from indicating one of the ON state and the OFF state to indicating another of the ON state and the OFF state and keeps indicating the other of the ON state and the OFF state over a predetermined operation determination period, to determine that the operation detection sensor has shifted from the one of the ON state and the OFF state to the other of the ON state and the OFF state; and
in case a signal from the attachment detection sensor changes from indicating one of the first state and the second state to indicating another of the first state and the second state and keeps indicating the other of the first state and the second state over a predetermined detection determination period, to determine that the attachment detection sensor has shifted from the one of the first state and the second state to the other of the first state and the second state, and
the detection determination period is shorter than the operation determination period.

11. The blower according to claim 7, wherein the control unit is configured:
to stop the prime mover in a first manner in case the operation detection sensor shifts from the ON state to the OFF state while the attachment detection sensor is in the first state; and
to stop the prime mover in a second manner in case the attachment detection sensor shifts from the first state to the second state while the operation detection sensor is in the ON state, and
a period required for the prime mover to stop in the second manner is shorter than a period required for the prime mover to stop in the first manner.

12. The blower according to claim 11, wherein
the prime mover comprises an electric motor,
the control unit stopping the electric motor in the first manner comprises the control unit stopping the electric motor by weak braking,
the control unit stopping the electric motor in the second manner comprises the control unit stopping the electric motor by strong braking,
a braking force of the strong braking is greater than a braking force of the weak braking, and
the braking force of the weak braking is greater than a braking force acting when the electric motor is stopped by freewheeling.

13. The blower according to claim 2, wherein the control unit is configured:
in case a signal from the operation detection sensor changes from indicating one of the ON state and the OFF state to indicating another of the ON state and the OFF state and keeps indicating the other of the ON state and the OFF state over a predetermined operation determination period, to determine that the operation detection sensor has shifted from the one of the ON state and the OFF state to the other of the ON state and the OFF state; and
in case a signal from the intake port detection sensor changes from indicating one of the first state and the second state to indicating another of the first state and the second state and keeps indicating the other of the first state and the second state over a predetermined detection determination period, to determine that the intake port detection sensor has shifted from the one of the first state and the second state to the other of the first state and the second state,
the detection determination period is shorter than the operation determination period,
the control unit is configured:
to stop the prime mover in a first manner in case the operation detection sensor shifts from the ON state to the OFF state while the intake port detection sensor is in the first state; and
to stop the prime mover in a second manner in case the intake port detection sensor shifts from the first state to the second state while the operation detection sensor is in the ON state,
a period required for the prime mover to stop in the second manner is shorter than a period required for the prime mover to stop in the first manner,
the prime mover comprises an electric motor,
the control unit stopping the electric motor in the first manner comprises the control unit stopping the electric motor by freewheeling,
the control unit stopping the electric motor in the second manner comprises the control unit stopping the electric motor by a three‑phase short‑circuit brake,
the blower further comprises:
an exhaust port through which air flows out due to rotation of the fan;
an exhaust port attachment member detachably attachable to the exhaust port; and
an exhaust port detection sensor configured to be in a third state when the exhaust port attachment member is attached to the exhaust port and be in a fourth state when the exhaust port attachment member is not attached to the exhaust port, and
the control unit is configured:
to drive the prime mover in case the intake port detection sensor is in the first state, the exhaust port detection sensor is in the third state, and the operation detection sensor is in the ON state;
to stop the prime mover in case the intake port detection sensor is in the first state, the exhaust port detection sensor is in the third state, and the operation detection sensor is in the OFF state; and
to stop the prime mover in case the intake port detection sensor shifts from the first state to the second state while the operation detection sensor is in the ON state or in case the exhaust port detection sensor shifts from the third state to the fourth state while the operation detection sensor is in the ON state, and thereafter, to prohibit driving the prime mover until the operation detection sensor shifts from the ON state to the OFF state.

14. The blower according to claim 8, wherein the control unit is configured:
to stop the prime mover in case the attachment detection sensor shifts from the first state to the second state while the operation detection sensor is in the ON state;
not to prohibit driving the prime mover until a predetermined period elapses since the prime mover was stopped; and
after the predetermined period has elapsed from when the prime mover was stopped, to prohibit driving the prime mover until the operation detection sensor shifts from the ON state to the OFF state,
the control unit is configured:
in case a signal from the operation detection sensor changes from indicating one of the ON state and the OFF state to indicating another of the ON state and the OFF state and keeps indicating the other of the ON state and the OFF state over a predetermined operation determination period, to determine that the operation detection sensor has shifted from the one of the ON state and the OFF state to the other of the ON state and the OFF state; and
in case a signal from the attachment detection sensor changes from indicating one of the first state and the second state to indicating another of the first state and the second state and keeps indicating the other of the first state and the second state over a predetermined detection determination period, to determine that the attachment detection sensor has shifted from the one of the first state and the second state to the other of the first state and the second state,
the detection determination period is shorter than the operation determination period,
the control unit is configured:
to stop the prime mover in a first manner in case the operation detection sensor shifts from the ON state to the OFF state while the attachment detection sensor is in the first state; and
to stop the prime mover in a second manner in case the attachment detection sensor shifts from the first state to the second state while the operation detection sensor is in the ON state,
a period required for the prime mover to stop in the second manner is shorter than a period required for the prime mover to stop in the first manner,
the prime mover comprises an electric motor,
the control unit stopping the electric motor in the first manner comprises the control unit stopping the electric motor by weak braking,
the control unit stopping the electric motor in the second manner comprises the control unit stopping the electric motor by strong braking,
a braking force of the strong braking is greater than a braking force of the weak braking, and
the braking force of the weak braking is greater than a braking force acting when the electric motor is stopped by freewheeling.
